(19) United States
(12) Patent Application Publication
(10) Pub. No.: US 2006/0075228 A1
(43) Pub. Date: Apr. 6, 2006

(54) Method and apparatus for recognition and real time protection from view of sensitive terms in documents

(76) Inventors: Alistair D'Lougar Black, Los Gatos, CA (US); Constantin Stelio Delivanis, Los Altos Hills, CA (US); Nicolas M. Heron, New York, NY (US)

Correspondence Address: RONALD CRAIG FISH;A LAW CORPORATION, P.O. BOX 820, LOS GATOS, CA, 95031, US

(21) Appl. No.: 11/235,955

(22) Filed: Sep. 27, 2005

Related U.S. Application Data
(63) Continuation-in-part of application No. 10/874,399, filed on Jun. 22, 2004.

(51) Int. Cl. H04L 9/00

(52) U.S. Cl. 713/167

(57) ABSTRACT

A process for automatically selecting sensitive information in any form of document being displayed and/or generated on a computer to select sensitive information for protection by encryption, redaction or removal of only the sensitive text. Selection is done by using pattern recognition rules, dictionaries of sensitive terms and/or manual selection of text. The sensitive text is automatically protected on the fly in the same manner as a spell checker works so that the sensitive information immediately is removed and replaced with the encrypted or redacted version or a space and a pointer to where the decryption key or the original of the redacted or removed text is stored. Other embodiments require manual approval of automatically selected text prior to protection. For encryption embodiments, the keys used to encrypt the sensitive information in each document are stored in a table or database, preferably on a secure key server so that they do not reside on the computer on which the partially redacted document is stored. Embodiments to protect the body of emails and attachments in either the email client or web mail environment are also disclosed.

### FIELD OF USE AND BACKGROUND OF THE INVENTION

There is a great deal of personal, sensitive information sitting in documents on personal computers desktops, browsers and email clients, databases and file repositories on servers. One of the problems with databases is that they are persistent, often last beyond the expectations and assumptions of the users. This creates a problem of a large amount of sensitive information residing in computers without any person knowing about it until the data is discovered by somebody accidently or is located by an unscrupulous person and used to steal identities, make fraudulent purchases, etc.

Protecting sensitive information such as social security numbers, addresses, mother's maiden names, phone numbers, FAX numbers, email addresses, income and employment information, and business confidential information etc. is becoming more important every day. Identity theft is one of the fastest growing crimes in America and worldwide. In addition, spammers and telemarketers are very interested in scavenging email addresses, phone numbers and physical addresses from as many people as possible so as to bombard them with offers to buy things. In addition, in lawsuits there is a constant need for redaction or removal of sensitive information from discovery documents to avoid revealing sensitive business information, the names of people and informants, trade secrets, etc.

Single pieces of information like social security numbers alone are usually not enough to commit a crime. It is when an unscrupulous person gathers a great deal of information about a person that identity theft can occur. It is important therefore to protect as much of the information about a person as is possible. And it is important to be able to efficiently redact or encrypt sensitive information in documents that could or will become part of the public record in a lawsuit or criminal prosecution. Since there are frequently thousands or tens or thousands of documents or even millions of documents in lawsuits, there is a need for a system which can automatically find information that needs to be redacted or encrypted or removed from a document or a system which can learn information to be redacted, removed or encrypted from observing manual selections made by an operator.

Microsoft recently introduced a redaction product which redacts documents created using Microsoft Word. This product relies on an operator to manually go through a document and select all the items of information for which the operator desires redaction. When a redaction command is given, the selected items are blackened out (removed altogether) in a copy of the document. This creates an original with the information still present and a copy with the selected information removed and its position in the document signalled by a blackened region. The problem with this approach is that the information redacted is permanently lost in the copy of the document so if the original is lost or destroyed, the information is gone forever. It also creates a tracking and storage problem since the originals for every redacted document must be stored and there must be some method for tracking which originals belong to each redacted copy. This is a non trivial task where there are thousands, tens of thousands or millions of redacted pages.

Sensitive information that needs to be encrypted or redacted or removed is entered into forms that are filled out on computers and in documents that are written on computers. Typically, these documents are written and forms are filled out on client computers and stored in databases and document repositories on servers to which the client computer is coupled via a network or are stored locally on the client computer or in both places. If there is internet access by the client computers and/or servers, or modem connections, hackers can break into the system and steal sensitive information from these databases and repositories. In addition, these documents and forms are sometimes sent over the internet in email which is not a secure medium (it is like sending a postcard) and can subject sensitive information to prying by persons with other than pure motivations.

The problem with encrypting entire files (documents) stored in computers is that the persons working with the files needs to decrypt them to work on the documents. This is a hassle and slows down work, so most people do not encrypt their files. Even if the files are encrypted, the key is on the computer somewhere usually. If the computer is stolen or sold at auction in a bankruptcy and the hard drive is not cleaned, sensitive information can be lost to unscrupulous persons if the documents are not encrypted or if they are encrypted and the buyer of the computer finds the key to decrypt the files.

Further, besides the theft and sale at auction scenarios, opportunistic crime is also on the rise. If the economy enters a recession or worse, opportunistic crime will rise as people turn to crime. Thus, even if all computers in an organization have user names and passwords to log on and even if documents stored on the computers are fully encrypted, the sensitive information in the documents is still not safe from employees working with the documents. In other words, unscrupulous employees of organizations who have access to sensitive information of customers can sell that information to crime rings. Employees have access to files they have to decrypt to work on and they have access to files which are not encrypted in able to do their jobs. There has been one documented identity theft case where a receptionist at a doctor's office sold sensitive information of patients to an identity theft ring which resulted in hundreds of identity thefts. In another case, a disgruntled employee who felt she was not being paid sufficiently posted the records of customers of her employee on the internet to damage her employer and subject it to lawsuits for breach of privacy.

It takes a great deal of effort and time on the part of an identity theft victim to straighten out ruined credit and get bill collectors off his or her case. Bill collectors are not susceptible to being easily convinced that their target was the victim of an identity theft.

Prior art document encryption systems such as Pretty Good Privacy encrypt the entire file using a paired public key, private key arrangement. To encrypt a document to be sent to a specific recipient, the user must send her public key to the sender who then uses it to encrypt the document. The encrypted document is then decrypted with the recipient's private key and read. All this is a hassle, and that fact makes the system only useful for highly secure communication. Further, such prior art does not protect the sensitive information if somebody steals the disk drive or the computer upon which the encrypted documents are stored or the computer is sold at auction and the new possessor gets access to the public and private key rings stored on the drive. The same is true for database systems such as Oracle which encrypt the database. Neither prior art system protects sensitive information from the authorized users thereof or from buyers of the computer or from thiefs if the keys to decrypt the files are stored on the computer. Further, passwords and keys can be surreptitiously learned using keyboard loggers which log keystrokes of a computer a hacker wants to break into and emails the keystrokes to some email address the hacker specifies.

Accordingly, a need has arisen for a method and apparatus to secure sensitive information in any type of document (such as a word processing document, database page, email, spreadsheet) created on a computer or received by a computer even from the person who enters it into a computer system or works with the documents. There is also a need for a system which can use a dictionary or rules database to automatically select sensitive text and redact documents or which can learn the types of information to be redacted by observation of an operator manually redacting information using the computer. The needed system will, in one class of embodiments, partially encrypt, redact or remove manually selected sensitive information from a document (which includes emails and their attachments) to protect just the sensitive information but otherwise leave the document in a readable state. In another class of embodiments, automatic selection of sensitive text with or without manual acceptance of each selection will be used to protect sensitive information from view. Automatic selection can be done using one or more dictionaries or rules database or learning from observation of manual redactions by operators to protect documents automatically.

In other words, the problem is that sensitive information is exposed to the extent the degree of security applied to the computer is weak. Further, sensitive information is always exposed to the employees of an organization that have to work with the data, and no amount of security applied to the log on process or encryption of individual documents can reduce that risk. There is a need to change that paradigm so that the data itself is secure even from the people who created the document or have to work with the documents (unless they have a photographic memory) and regardless of the degree of security applied to the computer itself.

Much software to encrypt entire documents is available. However, this software is not widely used because it is burdensome to do key exchanges and key maintenance and maintain records of which keys were used to encrypt which documents. Further, once the document is encrypted, it is no longer useable until it is decrypted. Partial encryption, redaction or removal of only the sensitive information still protects the document but leaves the document in a useable form.

The need has also arisen to correct the problem of sensitive information in databases. There is a need for a system that will automatically encrypt sensitive information in real time as it is entered into a database or any other type of document and store the keys, preferably elsewhere on a separate key server(s). There is also a need for a system which can protect documents already created where the application that created the document has no ability to have document protection functionality integrated therein using the DCOM or OLE automation interfaces.

### BRIEF DESCRIPTION OF THE DRAWINGS

FIG. 1 is a block diagram of a typical system in which the teachings of the various embodiments are employed.

FIG. 2 is a flowchart illustrating the genus of the encryption processes including the minimum steps that all species within the partial encryption genus must carry out. Steps 20, 22 and 24 define the genus of processes to create a partially encrypted document. Steps 26 and 28 define a separate genus to use the partially encrypted document.

FIG. 3A is a diagram illustrating a combination of information elements that a bank might have collected about its customers for purposes of authentication to verify they are who they say they are.

FIG. 3B is one example of a key storage table using a column for every document with the encryption keys for every piece of sensitive information in the document stored in rows in the column assigned to the document in which the keys were used.

FIG. 4 is a flowchart of a learning process to modify a set of rules to improve their selection accuracy.

FIG. 5 is a hardware block diagram that illustrates a typical installation in which the various embodiments can be practiced.

FIG. 6, comprised of FIGS. 6A and 6B, is a flow diagram of the preferred species of the various partial encryption and partial redaction embodiments that includes a learning process and an automatic error reporting process.

FIG. 7, comprised of FIGS. 7A and 7B, is a flowchart of an alternative embodiment where the client system does on the fly encryption and learning, but does not automatically report errors to a server somewhere, but stores them and waits of a server to ask for them.

FIG. 8, comprised of FIGS. 8A and 8B, is a flowchart of an alternative embodiment where a client system does on the fly encryption and learning only with no error storage or reporting.

FIG. 9 is a diagram showing the data structures of the encrypted sections of a document and an ID directory file which stores mapping entries which map document IDs and segment IDs to pointers to key servers and particular keys that were used to encrypt each encrypted segment.

FIG. 10 comprised of FIGS. 10A and 10B, is a flowchart of the security application process on the client computer and key server to create document IDs and segment IDs, send key requests, receive key requests and create mapping entries, issue keys and encrypt sensitive data.

FIG. 11 is a flowchart of a first species of a process to use public-private key encryption to partially encrypt document segments.

FIG. 12 is a flowchart of a second species of a process to use public-private key encryption to partially encrypt document segments.

FIG. 13 is a flowchart of a process carried out by a web application to remotely process documents stored on other computers to partially encrypt them or partially redact them.

FIG. 14 is a flowchart of the process to create a protected document with sensitive information removed.

FIG. 15 is a flowchart of the process to use the protected document created by the process of FIG. 14.

FIG. 16 is a flowchart of a process carried out by a stand alone partial encryption or partial redaction embodiment which works directly on documents already created using other applications by recognizing the application used to create the document and using templates to understand the document's data structure.

FIG. 17 is an example of an partial encryption or partial redaction or sensitive information removal process which is integrated into any application which supports OLE or DCOM automation, such as Microsoft Word at work.

FIG. 18 is a flow chart of a genus of processes to protect sensitive information in documents by partial encryption, partial redaction or partial removal of the sensitive information.

FIG. 19 is a flow diagram of an embodiment which requires manual approval of the manual selections of sensitive information before that sensitive information is protected by partial encryption, redaction or removal.

FIG. 20 is a flowchart of a process to use an Email client with a DCOM linked HTML editor which has document protection functionality integrated therein to protect incoming email.

FIG. 21 is a flowchart of the process to use an email client with a linked HTML editor with integrated document protection functionality to protect outgoing emails and their attachments.

FIG. 22 is a typical computing environment in which web mail protection of sensitive information can be practiced.

FIG. 23 is a flowchart of the process to compose and protect outgoing emails and attachments using web mail.

### SUMMARY OF THE VARIOUS EMBODIMENTS DISCLOSED HEREIN

A software process according to one embodiment for partial encryption or partial redaction or removal of sensitive information in documents works to automatically select and protect sensitive information either as it is entered in the document or after the document is created. The preferred process genus involves three steps: 1) detecting the presence of sensitive information; 2) protecting the selected sensitive information by preventing it from being viewed; 3) storing a means for bringing the sensitive information back to a state where it can be viewed. The detection and selection can be by dictionaries, rules or learning from manual selections, and, at least for encryption or sensitive information embodiments, can be manual selection. For redaction of document embodiments, selection must be automatic because of a prior art Microsoft redaction product the applicant is aware of (name unknown) which depends upon manual selection of text to be redacted. To the extens the Microsoft product is not capable of redacting other types of documents such as databases, spreadsheets, emails or their attachements, selection can be manual when using the invention to protect documents Microsoft's product cannot protect.

Protecting the selected sensitive information can be by encryption, redaction or removal of the selected information. In one important embodiment, after the sensitive information is selected by automatic means, the system stops and waits for manual verification of the selections and/or addition of additional selections by the operator. The step of storing means for bringing the sensitive information back depends upon the type of protection used. The details of these mechanisms are specified elsewhere herein, but generally involves storing pointers to the decryption keys or the original information stored elsewhere.

“Document” as that term is used in the claims and the specification means any word processing document, database, presentation slide, spreadsheet, incoming or outgoing or archived email, any attachment to an email and any other file or data structure which can be viewed by a user and which contains sensitive information. The use of the term document in sentences along with specific recitations of particular types of documents such as emails does not change the meaning of the term. The embodiments disclosed herein are about protecting sensitive information in documents without completely encrypting the document so as to leave the document in a useable form but with sensitive segments blocked from view by encryption, redaction or removal.

In another embodiment, the selected information is encrypted or redacted or removed only after some fixed or programmable delay or upon receiving a command from the user while otherwise leaving the document in a readable state. This process runs automatically in the background in some embodiments, and key management is automatic. In some embodiments, document protection runs automatically in background constantly after a document protection command is given. In other embodiments, document protection runs automatically in background at all times.

In one species, the process works much like a grammar or spell checker program except that the rules or dictionary entries or a learned set of words and phrases learned by the computer from observing manual selections of words and phrases to encrypt or redact are used to encrypt or redact or remove sensitive information instead of correct grammar or spelling. That it, the partial encryption or redaction process is a function within a word processor, email client, web mail browser, spreadsheet or database application to partially encrypt or redact or completely remove sensitive information in a document, spreadsheet, email, email attachment or database entries (or other type of document) on an ongoing, real time basis as an automatic background process.

With regard to redaction and removal embodiments, the redaction or removal of sensitive text is automatic (but manual approval of automatically selected text is required in some embodiments) using entries in a dictionary, rules database or learned text entries in a table or database which have been learned from observation by the computer of an operator manually selecting text in a document for redaction.

In the case of encryption embodiments, the encryption is automatic (but manual approval of automatically selected text is required in some embodiments) using entries in a dictionary, rules database or learned text entries in a table or database which have been learned from observation by the computer of an operator manually selecting text in a document for redaction. In other embodiments, protection is implemented by simply encrypting text selections which have been manually selected by an operator.

Such a background process embodiment is always running to recognize sensitive information and encrypt or redact it. In encryption embodiments, each piece of sensitive information is recognized, encrypted and the sensitive information is replaced with labelled segments which contain data to find the proper key to decrypt the encrypted version of the sensitive information. Typically, the sensitive information is replaced with the encrypted version thereof and suitable labels to find the proper key. The labels can be used to retrieve a key from a key server to decrypt the encrypted sensitive information.

In redaction embodiments, after the automatic redaction process is completed, a copy of the document exists on the computer with the redacted text selections removed and replaced by blacked out sections or sections which otherwise indicate where the redaction occurred. A link to the original text is also created. In the preferred embodiment, this linking information is stored in the redacted copy itself, and in other embodiments, the linking information is stored in a table or database along with a unique identifier that identifies the copy which has been redacted, the linking information pointing to the unredacted original.

In other species, the partial encryption or partial redaction or partial removal process may be practiced as a batch process on any email, .pdf, .doc, .xls, or .wpd file or on any other word processing, spreadsheet, database or other type of file or document containing sensitive text after the file has been completely created. In other words, the partial encryption or partial redaction or partial removal (hereafter sometimes just referred to as the protection process and references to redaction should be understood to mean either redaction or removal of the sensitive text) process is carried out out on a document input to said protection process after the document has been completely created earlier by another process running on the same or a different computer. Further, the batch protection process can be performed on a batch of documents designated by a user and input electronically to the protection process and the steps of the process are carried out on each document.

In the batch process, the emails, documents or files being processed do not have to be displayed on the computer. In the batch process, every time (or some predefined or programmable time later) a document is saved that may have sensitive information or an email is created or downloaded from a webmail server, the document, database or email and its attachments is automatically partially encrypted or partially redacted. Partial encryption or partial redaction is preferably done by one of two three methods.
1) In the first method, the partial encryption or partial redaction process and apparatus work directly on the files themselves and are not part of or integrated into another application like Word or Excel. Something in the prior art which is in some ways similar is the Java library calls that operate on Excel spreadsheet files directly.

This is discussed at the website http://www.andykhan.com/jexcelapi/.
2) In the second method, the process and apparatus launches an actual instance of an encyryption or redaction program in the background and operates on the opened file with a simple set of scripted commands such as find and replace that will automatically perform a scan of the text and the replacement of sensitive segments.
3) In the third method, the partial encryption or redaction process is integrated into another process carried out by some other application program (the host program) such as Word or Excel and can be invoked by giving a command from within the host program to operating on a document being created or processed by the host program.
   In another species, protection of sensitive information in any type of file is performed by creating a web application (such as those created using the Microsoft.net environment). In this species, the web application makes a function call to an application programmatic interface within Microsoft Word or Microsoft Excel, Corel Wordperfect, Netscape Navigator, Mac OS Safari, Microsoft Inernet Explorer, Mozilla Firefox or any other database, word processing or email client application to gain access to read a document, email, spreadsheet or database file. The web application then runs a background process that finds the sensitive information segments using a dictionary or rules or a table or database of phrases, names, addresses, words etc. learned from observation of an operator manually encrypting or redacting documents. The web application then performs encryption or redaction of the sensitive segment(s) through a process that is implemented by the web application.

In encryption embodiments, the keys for each encrypted segment are stored in a key server preferably located somewhere other than on the machine which stores the partially encrypted document and the sensitive text is replaced by the encrypted version. The sensitive segment(s) are then overwritten with the encrypted version thereof. A pointer with information sufficient to enable finding the key used to encrypt the sensitive segment or pointer information suitable to find the sensitive segment's encrypted version (stored elsewhere) and the key needed to decrypt it are then generated and stored in the document somewhere, preferably along with the encrypted version of the text.

In redaction embodiments, the sensitive text is removed in the copy and a link to the original text is created.

The open source Java Excel API that exists in the prior art can be used to allow non Windows operating systems to run pure Java applications which can both process and deliver Excel spreadsheets. Because it is Java, this API may be invoked from within a servlet, thus giving access to Excel functionality over internet and intranet applications. The Java Excel API allows reading Excel spreadsheets and generating Excel spreadsheets dynamically. It contains a mechanism which allows Java applications to read in a spreadsheet, modify some cells and write out the new spreadsheet. Because it is open source, the Java Excel API function library code can be modified to do the sensitive information segment recognition, encrypt or redact the sensitive information, store the keys used to encrypt encrypted information and replace the sensitive information with the encrypted version and store a pointer to the key needed to decrypt the encrypted information.

In alternative embodiments, the Java Excel API function which is modified according to the teachings of the partial encryption process is modified to store pointers in the documents to both the encrypted version of the senstive text (stored elsewhere) and the key needed to decrypt the encrypted version of the text. The Java Excel API function which is modified according to the teachings of the partial encryption invention then accesses the original Excel file and overwrites it with the protected version. This can be done locally on the machine on which the Excel files are stored or remotely using a web application that implements the process and which can access Microsoft Word or Excel files remotely over the internet, modify them and replace them on the client.

The Java Excel API function which is modified according to the teachings of the partial redaction process can be used to automatically recognize sensitive information to be redacted and redact it while keeping track of original document so that the redacted information in the copy will not be lost and can be retrieved from the original.

Recognition of sensitive information is important. Recognition of sensitive information is done using predetermined rules of recognition, one or more dictionaries or a database or table of sensitive information learned from observing an operator manually encrypt or redact some documents. In this way, words, phrases or entire sections of the document or database field being worked upon by the host word processor or spreadsheet or database program or sensitive information in emails being composed or viewed using an email client or web mail browser are selected for encryption or redaction either in real time or upon command or after some programmable or predetermined delay. In some embodiments, encryption or redaction is done after a predetermined delay on one or more documents after the user signals by giving a command to partially encrypt or redact the documents, and this can be done in the web application or in a security application which is stand alone on the computer or integrated into another application.

In encryption embodiments, the encryption is done and the sensitive information is replaced with an encrypted set of characters. The key to decrypt that information is not available anywhere on the client computer in the preferred embodiment and is stored in one or more secure key servers by a secure server process elsewhere on a network. Note that this means that sensitive data can be automatically destroyed in one or more documents without touching the documents themselves simply by destroying the keys.

In operation of the encryption embodiments, the client computers creates unique document IDs and unique segment IDs and send these to a key server with a key request. The key request requests a key to encrypt each piece of sensitive information as the sensitive information is encountered (or after a delay in some embodiments). In some non preferred embodiments, the real time encryption process is performed fully on the client computer or a stand alone computer not coupled to the network and the keys needed to decrypt each encrypted segment are stored on the stand alone computer. In these embodiments, all the encryption keys are stored in a file which is itself encrypted with a highly secure encryption system or an unbreakable encryption system such as a one time pad system.

In general, the novel genus of partial encryption processes is defined by the following characteristics that all process species within the genus will share.

1) All species will select sensitive information for encryption in a document being created in real time or in a batch of documents previously created in any way such as by using predetermined selection rules, a dictionary or manual selection or by learning which words etc. to select by observing manual selection on one or more documents carried out by an operator, or by any combination of these techniques.

2) That sensitive information will be encrypted using any encryption algorithm and a pointer to the key is stored. In some species, the sensitive information is replaced with the encrypted version, and pointer information to the key needed to decrypt the encrypted sensitive information. In this species, the sensitive information is replaced with its encrypted version both on the displayed version of the document and in any stored version of the document. This is done either as soon as the sensitive information is entered and recognized as a piece of sensitive information or after a delay in some species. In other species, the sensitive information is replaced with pointer information pointing to the encrypted version of the sensitive information and to the key needed to decrypt it.

3) The keys for each encrypted piece of information will be stored on a secure server elsewhere on the network or in a secure, encrypted file on the computer on which the document was created or input from any source and stored. In some species, public-private key pairs are used. In other species, secure protocols are used with a disposable session key being used to transfer information back and forth between the key server and the client computer. IDs and pointers and mapping files or ID directories will be used to find the key used to encrypt each segment of encrypted information.

The novel genus of processes to use the partially encrypted documents is defined by the following characteristics that all species within the genus will share.

1) Any user who is requesting access to a protected document in the clear must be authenticated as a person who is on a list of authorized persons who have access to the secure server or the secure file of keys.

2) If user is authenticated, appropriate keys in secure server or secure file to reconstitute segments of protected document or portions thereof for display, printing or re-storing as a non-protected document are located and supplied and the encrypted segments are decrypted.

Typically, selection and encryption processes that perform in accordance with characteristics 1 and 2 defined above will work in the background of other programs such as Microsoft Word, WordPerfect, Filemaker Pro, Quattro Pro, Oracle, Peoplesoft, any email client or any web mail browser or other programs. Typically, the partial encryption or redaction processes work like a spell checker and runs continuously to automatically select and encrypt sensitive information as it is entered or after a delay in some species.

In other species within the novel genus, a process called “automation” (formerly called OLE automation) is used to take advantage of an existing program's content and functionality and incorporate it into another application such as the partial encryption and partial redaction embodiments discussed herein. In this class of novel species, a partial encryption or redaction application is written which does the recognition and encryption or redaction of sensitive information in any of the ways described herein. Then the automation process is used to incorporate this security application into the functionality of Microsoft Word, Microsoft Excel or any other application program that is based upon the Component Object Model (COM) standard software architecture. COM is a standard prior art software architecture based upon interfaces and is designed to separate code into self-contained objects or components. Each component exposes a set of interfaces through which all communication to the component is handled. For example, the security application can use the Word write and edit functionality to create documents and then process them to protect the sensitive information using the automation process and the COM architecture. Likewise, the security application can use the Excel functionality to create, program, edit, print and do other things with Excel and then process the spreadsheet to protect the sensitive information therein. In this way, the security application does not need to have its own code to do the complicated calculation engine to provide the multitude of mathematicaly, financial and engineering functions that Excel provides. Instead Excel or Word is automated to “borrow” the basic functionality needed (such as file open, file save, etc.) and incorporate that basic functionality into the security application. The security application simply invokes whatever functions from Word or Excel or any other application written based upon the COM software architecture by making the proper function call(s) to the API of the module that performs the needed function. Other applications such as Oracle database software also provide application programmatic interfaces to allow other functionality to be added to it and allow the new partial encryption or redaction functions to call existing functions within the basic program. This software architecture allows the security application to sit between the user and Word so that Word or whatever the basic application is does not need to know about or understand the security function. Word, Excel and Adobe Acrobat all use the COM architure and can have a partial encryption or partial redaction security function integrated therein.

If the security application sits below Word and works on partially encrypting files created by Word, those files may have to be decrypted again before Word opens them if Word control codes get encrypted in the process of selecting text to be encrypted or redacted.

For application programs which do not provide API interfaces or comply with the COM sofware architecture, the partial encryption or partial redaction software stands alone and works on the files created by the application without being integrated into the application itself. In order to do this, the file's data structure must be reverse engineered so that the data to be partially encrypted or partially redacted can be found.

It is not always necessary to decrypt a file that has already been partially encrypted since some applications will not be bothered by the ascii text of an encrypted segment of a document or spreadsheet and will not malfunction.

The genus of novel processes which do partial redaction of a document is defined by the following characteristics which all species will share.

1) All species will select sensitive information for redaction in a document being created in real time or in a batch of documents previously created in any way such as by using predetermined selection rules, a dictionary or by using a table or database of sensitive information generated by learning which words etc. to select by observing manual selection on one or more documents carried out by an operator, or by any combination of these techniques.

2) That sensitive information will be redacted in a copy of the original document, and a link between the copy and the original will be generated and stored so that the original can be found again.

The novel genus of processes to use the partially redacted documents is defined by the following characteristics that all species within the genus will share.

1) Any user who is requesting access to a protected document in the clear must be authenticated as a person who is on a list of authorized persons who have access to the secure server or the secure file of keys.

2) If user is authenticated, the appropriate link to the original document from which the redacted copy was generated is followed and the original document is retrieved and displayed or printed.

The predetermined rules for selection of which information is encrypted can be as varied as the types of information to be protected and the rules will usually differ from one area of application to another and be dependent upon what types of information are considered to be sensitive enough to require encryption. The exact selection rules are not critical. Any selection rule that reliably picks out the sensitive information of a document for encryption will suffice to practice the process. Examples of the types of selection rules which may be used are:

1) By comparison of user entered information in the form of text, formulas, or other symbology to a dictionary of terms or items that need to be protected, and using the results of the comparison to select for encryption terms that are in both the dictionary and the document being drafted or filled in.

2) By examining the document being processed and applying rules for selection such as: words with initial caps that come in pairs or triplets are proper names; 7 or 10 digit numbers are phone numbers; 9 digit numbers with a pattern 3 digits followed by a space or hyphen followed by 2 digits followed by a space or hyphen followed by 4 digits are social security numbers; any number followed by one or more words which are capitalized with no period between the number and the next capitalized word is assumed to be an address; or any other pattern such as a form with has fields named “address” or “mother's maiden name” or “household income” or “bank account number” or “credit card number” any other sensitive information will have everything following the field label to the next field label selected for encryption.

3) By manual selection of text to be protected in any known way such as giving a protect command and pointing to the beginning and end of the text to be encrypted, or by dragging a mouse cursor over the text to be encrypted or by giving coordinates in the document of the beginning and end of the text to be encrypted. This manner of selection does not apply to the partial redaction embodiments working on Word because Microsoft has already released a product which does partial redaction on Word documents using manual selection, but it would apply to use of manual selection of sensitive information on documents or emails created or viewed using programs other than Word.

In some embodiments, there is a learning process to learn the patterns of text that is manually selected for encrypting or redaction and to learn text which is manually selected which was erroneously selected for encryption or redaction by operation of some rule but which was not sensitive information. In some embodiments, the user can invoke tools to point out overinclusion errors and underinclusion errors manually after a document has been processed by the automated process. These errors are then analyzed and one or more new rules and/or dictionary entries may be generated which if added to the existing rules and/or dictionary would have eliminated or reduced the chance of such errors occurring in the future. This learning process can add rules or delete or modify rules and/or dictionary entries as the learning process proceeds.

Once the text to be encrypted is selected, that text is removed and replaced by a coded word or phrase that can be used to later locate the encrypted text and decrypt it or which can be decrypted itself to reveal the original text. In redaction embodiments, once the text to be redacted is automatically selected using, for example, dictionary entries or rules or learned text, the selected text is automatically redacted from all documents against which the entries in the dictionary, rules database or learned text table or database is applied.

For species which partially encrypt or partially redact outgoing emails, the security application works with the email client or browser to partially encrypt or partially redact the email to be sent. The keys are then stored in a secure key server to which the recipient has secure access or the links to the original email are stored in some secure server to which the recipient has secure access. The recipient then logs onto the secure key server or secure original document storage server and authenticates himself or herself. The appropriate keys are then retrieved and the email is decrypted and displayed to the email recipient, or the appropriate original document is retrieved and displayed to the email recipient.

After the email is read, it is re-encrypted and stored in the email archive, or the redacted copy is stored in the archive and the “in the clear” copy is erased from the computer. In some embodiments, a local set of dictionaries or rule sets are used to re-encrypt and in other embodiments, the segments that are decrypted are stored in cache along with their encrypted versions and are substituted back into the email before archiving at the places in the email that match the decrypted text or just the encrypted version of each sensitive piece of information is stored in memory and a marker where each belongs in the email is stored with the encrypted text and in the email where the encrypted text is supposed to be inserted. Then, when the email is archived, the encrypted versions of each piece of sensitive information are reinserted at the appropriate place in the email prior to archiving.

Access to the partially encrypted emails in the archive folder can be enabled by storing the keys for each encrypted portion in a password protected key folder on the local computer where the archived emails are stored.

### DETAILED DESCRIPTION OF THE PREFERRED AND ALTERNATIVE EMBODIMENTS

The Encryption Embodiments

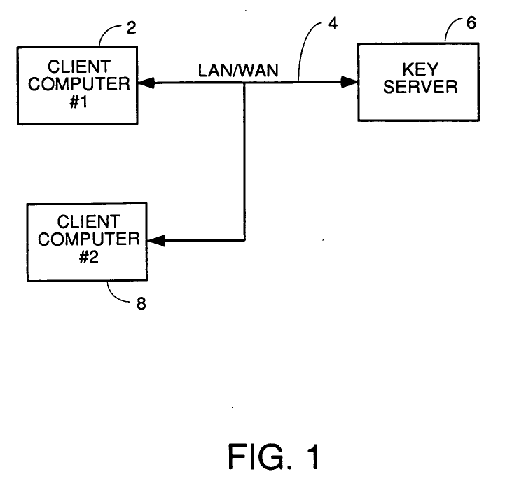

FIG. 1 is a diagram illustrating the typical computing environment in which the various embodiments can be found working on documents or files. Hereafter, documents of any type including word processing documents, spreadsheets, pdf documents, emails, email attachments and databases may be sometimes also be referred to simply as files. Client computers 2 and 8 upon which documents with sensitive information are being typed or otherwise processed, are coupled via local area or wide area network 4 to a key server 6. Each client computer typically has a keyboard, display, pointing device, central processing unit and usually has some sort of bulk storage device to read and write data on media such as a hard disk drive, CD-ROM, etc. The client computers execute a security application program that recognizes sensitive information in a document, obtains a key to encrypt the sensitive information and immediately or after some delay encrypts the sensitive information and then stores the encryption key.

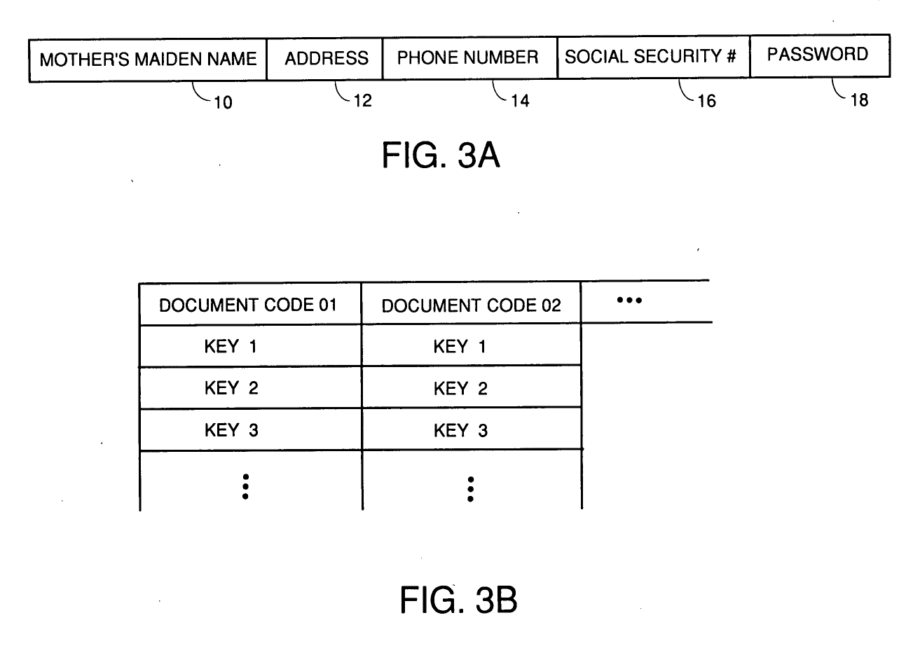

The encryption keys for each document are stored in a table like that shown in FIG. 3B where all the keys for all the encrypted pieces of information in a document are stored in a column which is designated with the code of the document, the collection of columns each having rows which are the encryption keys comprising a table. In the preferred embodiment, the table is stored in key server 6. The encrypted text in each document is appended or prepended or otherwise associated with a pointer to the key used to encrypt it or an identification code of the key used to encrypt the sensitive information. The identification code or pointer used to find the key needed to decrypt each piece of sensitive information should allow for change of name of the document and/or the deletion or re-ordering of various segments of the document/database without requiring renumbering of the identification codes or otherwise altering of the pointers.

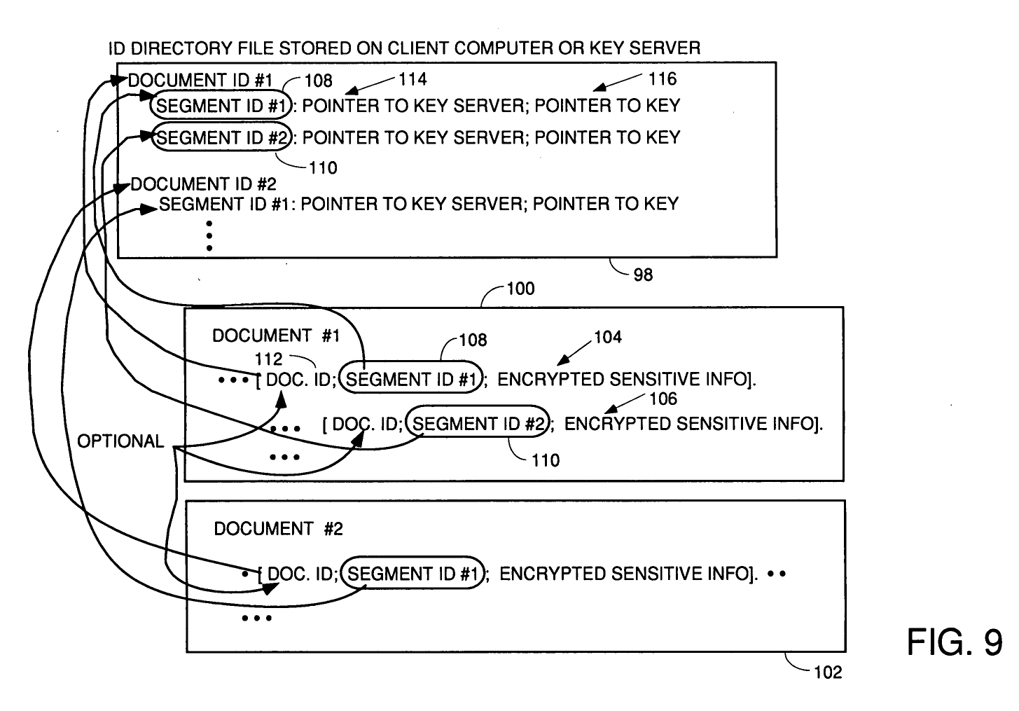

Key management can be done in several ways. The first way, illustrated in FIG. 9, is to keep a separate ID directory file 98 managed by the security application that stores all the document IDs, encrypted segment IDs for encrypted segments in each document and pointers to the key server which stores the key used to encrypt the segment along with the information needed to find the correct key. Each segment IDs must be connected to the appropriate segment in the document. In the preferred embodiment, this is done through a coding which places a segment ID at the front of each encrypted piece of data. The segment ID must have a large enough number of bits and be generated in such a way as to prevent accidental use of the same number within the group of documents within the system (or at least within the same document if some other means of separating the keys for each document is used). For example, suppose two documents 100 and 102 each have encrypted segments. Document 100 has two encrypted segments at 104 and 106. Each of these encrypted segments has its own unique segment ID prepended to the encrypted text at 108 and 110, respectively. These encrypted segment IDs 108 and 110 are included in separate entries in the ID directory file 98 under a section labelled document ID #1. Document ID #1 is a unique document ID that does not change when the name of the document 100 is changed and which is unique within the system such that one and only one document is referred to by document ID #1.

Each segment ID entry in the ID directory file 98 includes a pointer to the key server upon which the key used to encrypt that segment is stored, and a pointer to the actual key used to encrypt the segment, shown at 114 and 116, respectively. Also placed at the front of each encrypted segment, in one embodiment, is a document ID that uniquely identifies the document (regardless of its filename) and relates it to the ID directory file that holds all the pointers to keys used to encrypt segments within that document.

In the embodiment illustrated in FIG. 9, every encrypted segment such as segment 104 in document 100 has prepended to it a document ID shown at 112 that uniquely identifies the document. In some embodiments, the document ID also serves to point to the particular ID directory file 98 as the file which stores all the pointers to the key server and keys for document 100 and which also includes the document ID. In some embodiments, the document ID does not have to also point to the ID directory file because the security software knows where the proper ID directory file for this document is. An example would be an embodiment where there is only one ID directory file per client computer. Another example would be an embodiment where there is only one ID directory file stored on the key server and serving the entire system.

In alternative embodiments, only a segment ID which is globally unique need be prepended to the encrypted segment since the uniqueness of the segment ID assures that it can be found in a search of all ID directory files like file 98 in the system. Use of a unique document ID in addition to a unique segment ID allows the size of the segment ID in terms of bits to be smaller as it is the concatenation of the document ID and the segment ID which is globally unique and which allows the proper key to be found.

The document ID and segment IDs (or just the segment ID in embodiments where only a globally unique segment ID is used) prepended to each encrypted segment of a document must be unique, or at least the combination of the two must be unique. In the preferred embodiment, each of the document ID and the segment ID is a 128 bit code. In an alternative embodiment, a separate ID directory file on the client computer (that may itself be encrypted) contains translations that take the unique segment IDs and relates them to an index on the key server that points to the document in which the encrypted segment resides and points to the proper key required for decryption.

The advantage to this first class of embodiments is that the required IDs may be smaller since there is not one big ID directory file on the key server which contains the document IDs for every partially encrypted document in the system and the segment IDs for every segment in every document without duplication of document IDs or segment IDs. Such a centralized system would require fairly large IDs to avoid duplication, but would be simpler. The disadvantage of the first class of embodiments is that the IDs can be smaller, but, since there are more ID directory files, the system is more complex.

A second class of embodiments stores on the key server a single ID directory file containing the keys for all encrypted segments of all documents on the system. In this class of embodiments, one simply makes the Directory ID and the segment ID large enough in terms of bits to assure that they can hold a unique number which points to a key on the key server without duplication even though the keys for a large number of encrypted segments are stored in the same ID directory file on the key server. In this embodiment, the security software has to be smart enough to create a unique document ID each time using any of the many techniques known in the art. For example a time stamp combined with other techniques may be used to create the document ID when the first segment is encrypted, and then the same document ID is used thereafter to encrypt all other segments in the same document. Time stamps along with other known methods can also be used to create unique segment IDs. Unique segment IDs at least within a document are a must, and the segment IDs must be created such that when a segment of a document containing encrypted portions is deleted, the segment IDs of the deleted portions are not later duplicated in other parts of the document. When a section of a document containing encrypted sections is copied, the encrypted sections can be decrypted using the same keys that are identified in the copied encrypted sections. In cases where a section containing encrypted text is deleted and replaced with sensitive information, a new key is used to encrypt the sensitive information and a new segment ID is created and a new entry in the appropriate ID directory file for the new encrypted segment or segments is created.

The document ID and segment ID (or just the segment ID in embodiments where the segment ID is globally unique) must be sent to the key server each time a key is requested to encrypt a segment of a document. This allows the security application executing in the key server to associate the key it issues with the document in which the key was used to encrypt a segment and to create a link between the encrypted segment, the key used to encrypt the segment and the document in which this encryption occurred. In some embodiments, the entry created by this linking is stored in a single ID directory file stored on the key server. In other embodiments, the entry created by this linking is sent to a secure ID directory file stored on the client computer on which the document or database having encrypted segments is stored.

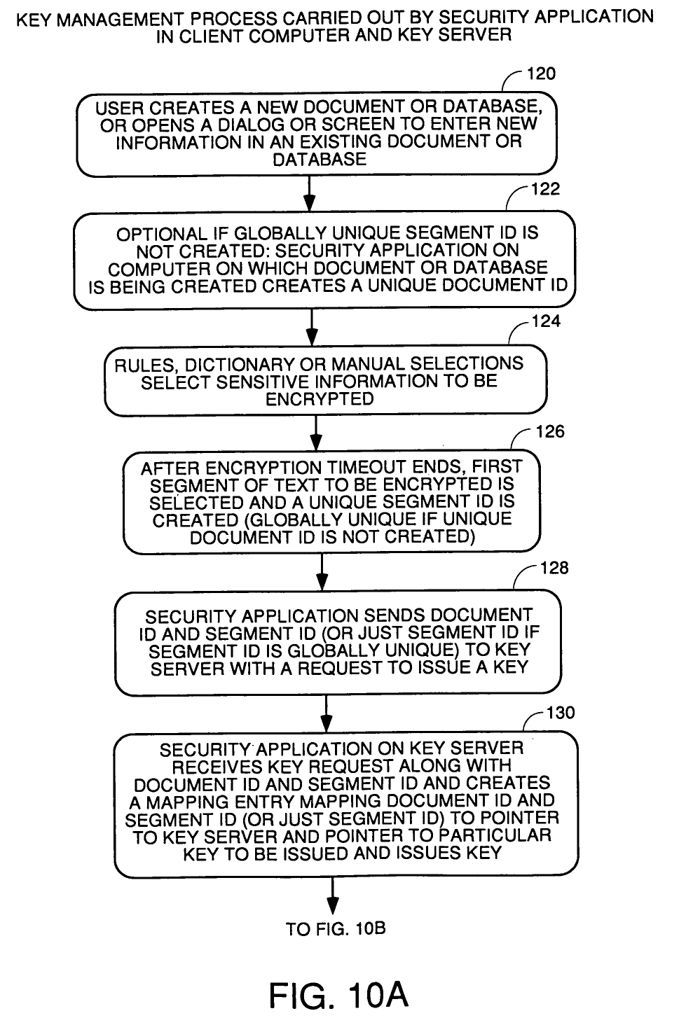

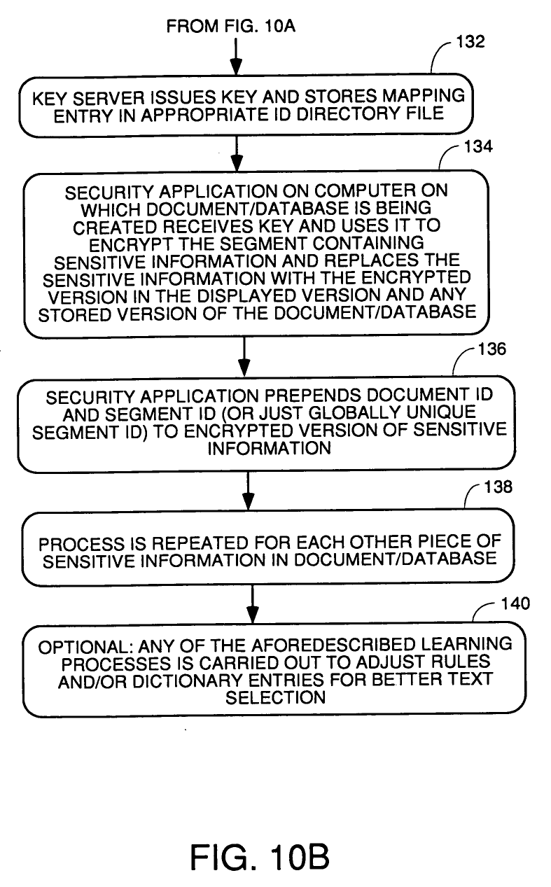

Referring to FIG. 10 comprised of FIGS. 10A and 10B, there is shown a flowchart of the security application process on the client computer and key server to create document IDs and segment IDs, send key requests, receive key requests and create mapping entries, issue keys and encrypt sensitive data. The process starts out with step 120 representing the user creating a new document or database or opening a dialog box or screen to enter new information in an existing document or database. Step 120 is an optional step which is performed if globally unique segment IDs are not created and a document ID is needed to combine with the segment ID to make a unique combination. “Globally unique” in this context means a segment ID which is unique within the universe of documents and/or databases within the system of key servers, other servers and client computers and not necessarily in the entire world. Assuming a globally unique segment ID is not being created, step 120 represents creation of a unique document ID that will not change even if the file name of the document is changed. This is done by the security application on the client computer where the document or database is being processed in response to the creation of a new document or new database or opening an existing document or database or opening a dialog or other computer display to add new information to an existing document or database.

Step 124 represents the process of using the predetermined selection rules and dictionary entries and/or manual selections to select sensitive text for encryption. In the one embodiment, this can be implemented by dragging over text to be encrypted and selecting an encrypt command. Of course, in databases, the fields have semantic labels, and the fields associated with each label can be predetermined to be sensitive or not depending upon the semantics of the label. For example, a customer identity database which includes fields in which are entered name, address, social security number and mother's maiden name along with other non sensitive fields requires only rules that say whatever is entered in the name, address, social security number and mother's maiden name fields is to be encrypted because we know that information is sensitive in advance and no further processing is needed. Step 126 represents the process of waiting for an encryption timeout to occur and then selecting the first segment of sensitive text to encrypt and creating a unique segment ID for that segment of text. The timeout could be zero meaning immediate encryption upon entry or it could be some programmable number set by the user to allow for proofreading or quality control. The step of waiting for timeout could also be eliminated and sensitive information could be immediately encrypted upon entry and recognition in one important class of embodiments. The unique segment ID must at least be unique within the document, and if no unique document ID is created in addition to the segment ID, then the segment ID must be created to be “globally unique” as that term was earlier defined.

In step 128, the security application sends the document ID (if any) and the segment ID (or just the segment ID if it is globally unique) to the key server with a request for a key for use in encrypting the text associated with the segment ID. In step 130, the key server's security application receives the key request and responds by creating a mapping entry such as any of the ones shown in ID directory file 98 in FIG. 9. The ID directory file may be stored on the client computer where the request originated, some other computer in the system or on the key server. The mapping entry associates the document ID to the segment ID to a pointer to the appropriate key server upon which is stored the key used to encrypt the segment uniquely identified by the document ID and segment ID and a pointer to the particular key used. Where the ID directory file is stored depends upon the particular species within this class of embodiments. Step 132 represents the process of the key server issuing the key and storing the mapping entry in the appropriate ID directory file. Step 134 represents the process of the security application on the computer on which the document/database is being created or processed receiving the key and using it to encrypt the segment associated with the segment ID. Step 134 also represents the process of replacing the sensitive text with the encrypted version.

Step 136 represents the process of the security application on the client computer prepending the document ID and segment ID (or just the segment ID if a globally unique segment ID was created) to the encrypted text. Step 138 represents the process of repeating the above described process for each other segment of sensitive text to be encyrpted. Step 140 represents an optional step of carrying out any of the learning processes described herein to adjust the rules and/or dictionary entries for better text selection.

It may be confusing to an operator to have sections of a document disappear before their eyes in real time and be replaced with encrypted text. Operators who wish to proof their typing may be frustrated by this. Accordingly, in some embodiments, a delayed encryption by some fixed or programmable time is used to allow the document to be completed or proofread or for checking against a list for completeness. In these embodiments, the text selected for encryption should be hightlighted, underlined or in any other way signalled to the user before it disappears into encrypted state so that the user can tell which parts of the document need to be checked. In some embodiments, the document is not processed for encryption of sensitive information until the user requests the document or a batch of documents to be processed to select the sensitive information and encrypt it or the sensitive information is not encrypted until after some fixed or programmable delay. For batch processing, a template of the file's data structure is preferred. In some embodiments, a fixed or programmable delay may be implemented for proofreading, but some information may be so sensitive that it is desirable to have it encrypted immediately even though the remaining items of sensitive information are not encrypted immediately. This can be implemented, in one species, by the user marking items of extremely sensitive information with some special, predefined control characters or prearranged symbols which signal the security application that the items of information so marked must be encrypted immediately even though the remaining items of sensitive information not so marked are to be encrypted only after some delay.

In a second species, a hot key combination is used which causes encryption on the fly. In this species, whenever the user presses the hot key combination, the security application encrypts whatever the user types “on the fly”, i.e., as the user types it. Encryption continues until the user presses the hot key combination again or presses another prearranged hot key. The text that is encrypted is replaced with the encrypted version thereof and a pointer to where the key to decrypt it may be found. In a third species, whenever the user presses a hot key, whatever is being typed is encrypted and the encrypted information is stored somewhere and the information being typed is replaced with a predefined set of characters the type of which is established in a configuration file. For example, a configuration setting may be set to replace the text being typed and simultaneously encrypted with a predefined name such as Bruce Smith or another setting may be made to replace the text being typed and simultaneously encrypted with x's or asterisks. In either case, the predefined text is stored where the original information was along with pointers to where the encrypted version of the original information and a pointer to the necessary decryption key is also stored.

Returning to the consideration of FIG. 1, in the preferred embodiment, the security application executing on client computers 2 and 8 each works like a spell checker which checks to recognize sensitive information constantly in the background. When sensitive information is recognized, the security application immediately requests a key from the key server and encrypts the sensitive information and replaces the display of the sensitive information with the encrypted information.

FIG. 3A is a diagram illustrating a combination of sensitive information elements that a bank might have collected about its customers for purposes of authentication to verify they are who they say they are. While the content of these identity templates will vary from business to business, the identity template of FIG. 3A is fairly typical. Block 10 stores the customer's mother's maiden name. Block 12 stores the customer's address. Block 14 stores the customer's phone number. Block 16 stores the customer's social security number. Block 18 stores a password selected by the customer. The concatenation of this information, when correctly recited by a customer on the phone, virtually assures that a customer is who he says he is.

All this information can rarely be found in a single document. However, if an identity thief has access to enough documents containing information about a person, such an identity template can be patched together. For example, one document may have a victim's mother's maiden name and address. Another document may have the victim's address and social security number and phone number. Another document may have the victim's social security number and the user selected password. It is important to encrypt all these pieces of sensitive information in all documents in which they appear such that if an identity thief somehow gets access to a number of documents containing information about an individual, the identity thief still will not be able to patch together an identity template.

This problem was not as severe when documents were stored on paper. But now that databases exist that contain a wealth of information about individuals and other documents exist in electronic form which also contain information and which can be easily hacked into, the problem has become much worse. Documents in electronic form sit around on the hard drives of non-secure personal computers, are backed up sometimes and can be accessed remotely over the internet. Worse, when a company goes bankrupt and is liquidated, its computers can fall into the hands of unscrupulous individuals, including ex-employees of the bankrupt company who buy computers at auction and who know the passwords. These unscrupulous people may sell the sensitive information found on the hard drives of client computers and servers unless somebody has the presence of mind to wipe the drives clean or change the passwords before the liquidation auction.

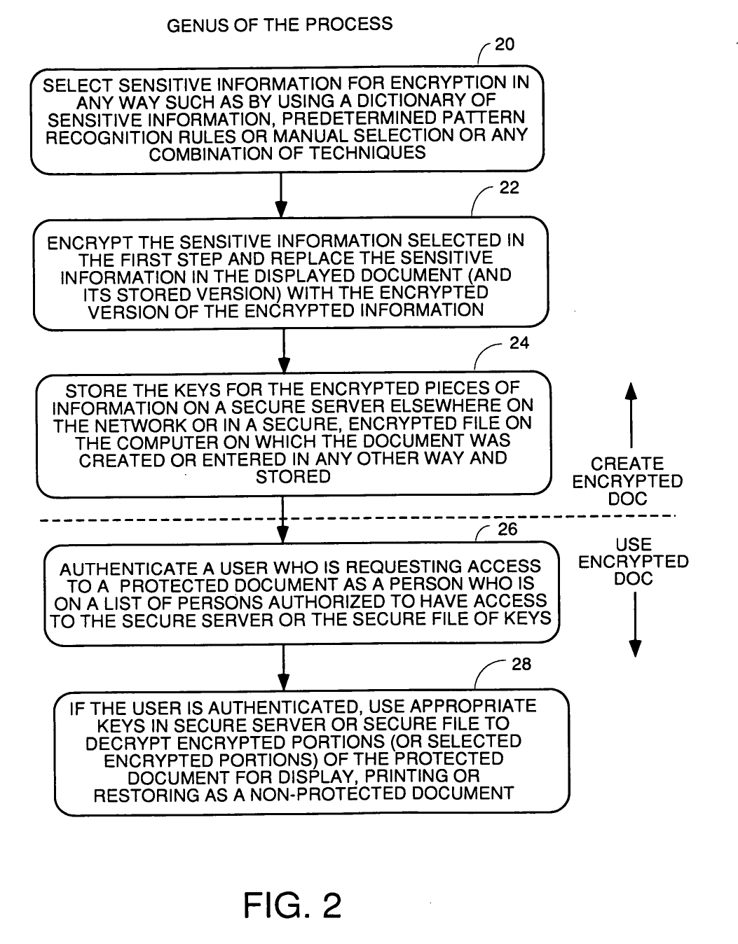

The Encryption Process Genus: FIG. 2

The solution to this problem is to detect sensitive information such as information that might be in an identity template, immediately encrypt the sensitive information as it is entered in the computer and then store the keys in a secure manner. There are many ways of doing this general process, but we start with a general description of the process genus, represented by the flowchart of FIG. 2. Step 20 represents the process of selecting sensitive information in a document or database record for encryption. This can be done in any way. One way is to use one or more dictionaries of sensitive information and to look up each word or phrase as it is typed to determine if there is a match with any entry in the dictionary. In some embodiments, different dictionaries are used for different purposes depending upon the type of document a user is working on, and the user can turn particular dictionaries on or off based upon the job the user is doing.

Another way of selecting the sensitive information for protection is to allow the user to manually select sensitive information for encryption. This can be done by dragging a mouse driven cursor over text to be encrypted and giving an encrypt command. Encryption and storing of the key in a secure file would then follow automatically. Another way of selecting information for encryption in database records is to use the semantic label of each field in a database record and to decide in advance which fields will contain sensitive information such as name, address, income level, mother's maiden name, etc. Then whatever information is entered in these preselected fields will automatically be encrypted while the information in other fields will be left unencrypted. Another way of selecting sensitive information for encryption would be through use of predetermined pattern recognition rules. Examples of such rules will be described below. Another way is to automatically select for encryption whatever is entered in blank fields following certain field labels on a form a user fills out on a computer. For example, a form may have fields for mother's maiden name, social security number, telephone number, zip code, address, credit card number, bank account number, etc. All these pieces of information would be valuable to an identity thief. As a result, all fields of the form that have field labels indicating what is filled in the field that follows the label or is associated therewith will be selected for immediate encryption. In the preferred embodiment, a combination of all these methods is used.

Step 22 represents the process of encrypting the sensitive information selected in step 20 and replacing this sensitive information with the encrypted version thereof and a code or other pointer by which the key to descrypt that segment can be found. Typically, the encrypted text is prepended by a code which can be used to look up the key used to encrypt that segment of text. The keys and their corresponding codes are stored in a secure key server in the preferred embodiment, but in other embodiments, the keys and codes can be stored in a password protected file on the same computer where the partially encrypted document is stored. In the preferred embodiment, this encryption is done immediately upon entry of the data and recognition that it is sensitive. In alternative embodiments, the sensitive information can be encrypted after a fixed or programmable delay or only after the user gives an encrypt command. In an alternative embodiment, the sensitive information can be replaced with a locator key which can be used to locate the encrypted version which may be stored elsewhere on a secure server or in a secure file on the same computer on which the document being processed resides. In these embodiments, the encrypted version of the text does not appear in the document where the original text was, only a locator code.

Immediate replacement of the sensitive information with its encrypted version or a locator key results in a piece of sensitive information immediately disappearing from the display and any stored version of the document immediately upon entry of the information. This prevents unscrupulous employees from memorizing the information. For example, suppose a mortgage loan officer is filling out a mortgage loan application on a client computer with a form having fields to enter bank account numbers, current address, credit card numbers, etc. Each of these pieces of information is sensitive information and would be recognized as such in step 20. As soon as the loan officer types in an entry into any one of these fields, it will be instantly encrypted and replaced with the encrypted version.

In some embodiments, public-private key pairs are used to encrypt pieces of sensitive information. In these embodiments, a public key is used to encrypt each segment of sensitive information selected in step 20, and then the public key is discarded. Then a pointer to the public key (or the private key since they come in pairs) and identifying the particular segment of a document or database record which was encrypted with said public key is generated and stored in the document itself or is stored in some secure file on the client computer which processed said document or database record or is stored on the key server.

One preferred way of generating and storing such a pointer is to generate a unique segment ID for each encrypted segment and, if the segment ID is not globally unique as explained in connection with the discussion of FIGS. 9 and 10, generating a unique document ID which does not change when the name of the file containing the document or database record is changed. The globally unique segment ID is then prepended to the actual encrypted version of the sensitive information in the document or database record and the encrypted version and the globally unique segment ID are then used to replace the sensitive information in the document or database record. If a globally unique segment ID is not used, a segment ID which is unique within the document or database itself along with the document ID is prepended to the encrypted version of the sensitive information and used to replace the sensitive information in the document, as illustrated in FIG. 9.

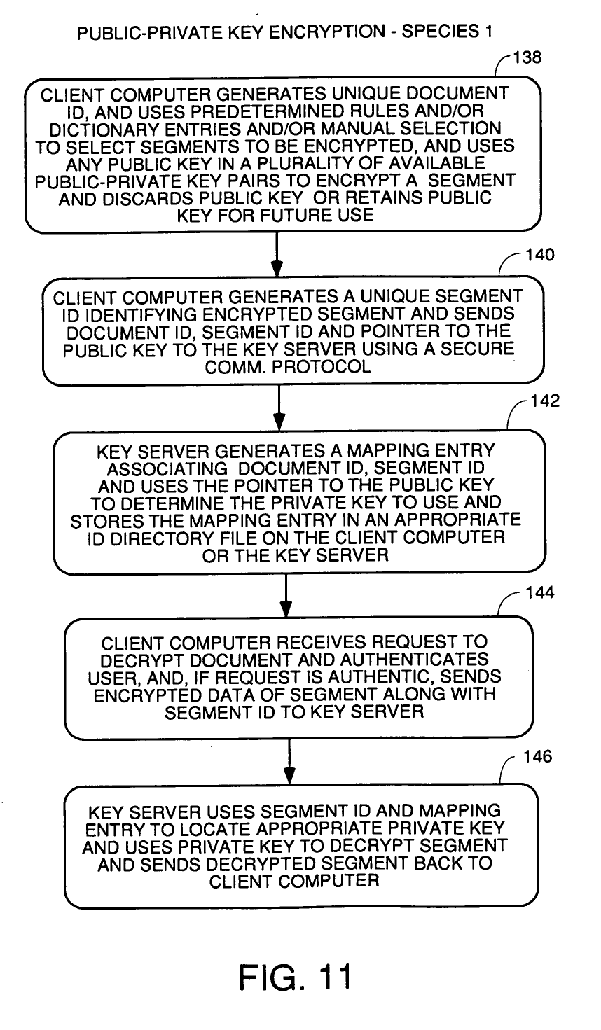

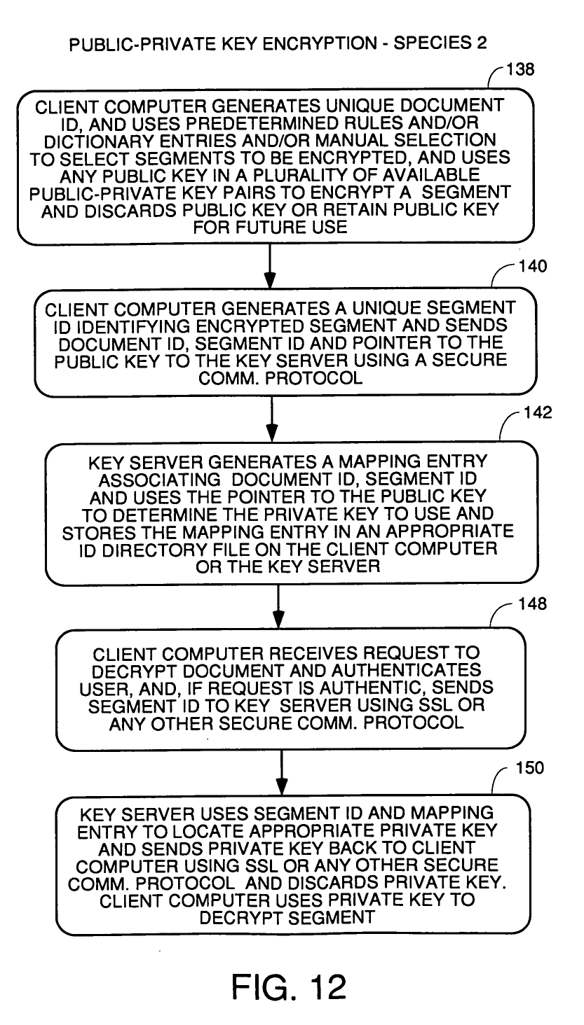

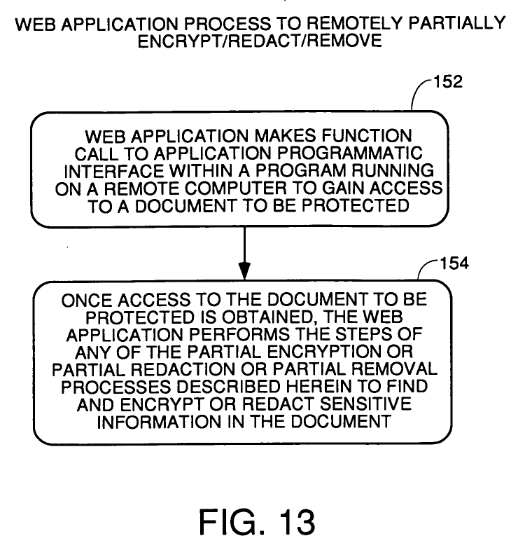

Two processes to use public-private key encryption are illustrated in FIGS. 11 and 12. Referring to FIG. 11, step 138 represents the client computer generating a unique document ID when a new document or database is created. This step is skipped when the user opens an already existing document or database which already exists and which has been partially encrypted, and the existing document ID, and new segment IDs and pointers to the public key used to encrypt each segment are sent to the key server for purposes of generating a mapping entry.

Step 138 also represents the process of selecting sensitive information to be encrypted by using the predetermined rules and/or dictionary entries and/or manual selection of sensitive information to be encrypted. Step 138 also represents the process of encrypting each sensitive information segment using a public key selected from a plurality of public-private key pairs which are available for encryption. After encryption of a segment, the public key is discarded. In alternative embodiments, the public key may be retained for future use so as to not deplete the public-private key pair pool.

Step 140 represents generating a unique segment ID for each sensitive information segment which is encrypted and sending the segment ID, the document ID and a pointer to the public key used to encrypt the sensitive information to the key server. In the preferred embodiment, the transmission of the segment ID, document ID and pointer to the public key is transmitted to the key server using the secure SSL or any other secure communication protocol. In the preferred embodiment, the encrypted information and the document ID and the segment ID are concatenated and used to replace the sensitive information in the document.

Step 142 represents the key server process of receiving the document ID, segment ID and pointer to the public key and creating a mapping entry for an ID directory table stored on a client computer or the key server. The key server uses the pointer to the public key to find the corresponding private key and records the private key or some pointer thereto in the mapping entry so that the document ID, segment ID and private key can all be associated. The key server then stores the mapping entry in the appropriate ID directory file.

In step 144, the client computer receives a request to decrypt a document or database record, and responds by authenticating the user. If the requester is authentic and is authorized to have the decryption performed, the client computer sends the encrypted data to be decrypted along with the segment ID to the key server. The key server uses the segment ID as a search key to search the ID directory file and find the private key needed to do the encryption in step 146. The key server then uses the private key to decrypt the encrypted segment received from the client computer and sends the decrypted data back to the client computer for inclusion in the document or database. In some embodiments, the decrypted data is sent back from the key server using a secure SSL protocol or any other secure communication protcol. In general, all communications with the key server can be made in various species using a secure SSL or any other secure communication protocol which uses a session key to encrypt the data transferred and discards the session key after the session is finished.

FIG. 12 represents another species similar to the species of FIG. 11 but wherein the decryption is done by the client computer using the private key sent by the key server. Steps 138, 140 and 142 are identical to like numbered steps in FIG. 11. The difference arises in steps 148 and 150. In step 148, the client computer receives a request to decrypt a document or database and authenticates the user. If the user is authentic and is authorized to have the decryption, step 148 sends the segment ID of each segment to be decrypted to the key server using the secure SSL or any other secure communication protocol. The key server uses these segment IDs to look up the private keys that will be needed to decrypt the segments in step 150 and sends the private keys to the client computer using the secure SSL or any other secure communication protocol, and then discards the private key(s). The client computer uses the private key(s) to decrypt the segment(s) and displays the decrypted data in the displayed version of the document or database record.

Returning to the consideration of the generic process of FIG. 2, step 24 represents the process of storing the encryption keys used to encrypt each piece of sensitive information on a secure server coupled by a local area network to the client computer on which the document is created or input in any other manner. In the case of a document containing sensitive information being created on or input to a stand alone computer, the encryption keys are stored in a secure file on a stand alone computer. The secure file may be a hidden file in some embodiments. The same key may be used to encrypt all items of sensitive information in the same document or a different key may be used to encrypt each piece of sensitive information. In the preferred embodiment, every document is given a unique code and each piece of sensitive information is encrypted with a unique key. The unique document code with the unique key for each piece of sensitive information are then stored, usually together, in a table or database for later retrieval. One example of such a key storage table is shown in FIG. 3. In this embodiment, a table is used with one column devoted to each document. Each column has a plurality of rows in which the individual keys are stored that were used to encrypt the various pieces of sensitive information in the order in which the sensitive information was encountered. In other embodiments, each piece of sensitive information is numbered, and the rows of each column are correspondinging numbered. The key used to encrypt each numbered piece of sensitive information is then stored in the corresponding numbered row. In other embodiments, each key has appended or prepended to it the document identifier and an identifier that identifies which piece of sensitive information was encrypted with the key. The resulting string is stored in a table or database.

After a document is protected in the manner of steps 20 through 24, it must be decrypted to be usable. However, access to the decrypted document can be limited to just one or a handful of trusted employees. This may be done by keeping a list of who is authorized to access a collection of documents or even a list of who is authorized to access a particular document. Step 26 represents the process of authenticating a user who has requested access to a document to verify the user is who he says he is and whether he is on the list of persons authorized to have access to the document or collection of documents. This authentication process can be by any known security method such as by challenging for a user name and password, automated voiceprint identification, automated retinal identification, automated fingerprint reader, etc. Once the person is authenticated, step 26 also checks his identity against the names or numbers of persons on the list of persons authorized to access the document.

Step 28 represents the process of receiving a request from a user authenticated in step 26 to decrypt a particular document, looking up the appropriate keys for decryption of the document and decrypting the pieces of sensitive information in the document for display, printing or re-storing as a document in the clear. The keys are looked up using the document identifier and the identifier of each piece of sensitive information in the document as search keys to search the table or data base in which the keys are stored.

Example Rules for Selection of Sensitive Information for Encryption

Some typical rules for automated selection of sensitive information for encryption follow. A set of rules is needed for each type of sensitive information that needs to be recognized, removed and replaced with an encrypted version. For the examples that follow, assume that a word processing document is being screened by the recognition rules (as opposed to a spreadsheet). The principals of rule based identification are the same in both cases however.

In the preferred embodiment, a temporary dictionary of encoded items of sensitive information is kept so that the document may be re-scanned and other instances of sensitive information that may have previously gone undetected may be discovered.

Note that the rules are preferably tight because over inclusion of material for encryption does not harm the security offered nor harm the document. For example Rule 1 below for recognition of proper names will result in two word city names also being encrypted such as Saint Paul or Grand Rapids or El Segundo. However, the city names are not lost nor does it do serious harm to encrypt them. Since the partially encrypted document in not really useful until it is decrypted, the encryption of the extra information does no harm. Social Security Numbers

Social security numbers take the pattern xxx-xx-xxxx such as 123-45-6789.

Rule 1: a typical automated recognition rule for social security numbers would be:
Does the number have a total of 9 digits?
If so, does the number take the pattern 3 digits,-, 2 digits,-, 4 digits where “-” could be a hyphen, a space or any other filler character?
   If the answers to both these questions is yes, the number is deemed to be a social security number and is selected for encryption.

Rule 2: where the SSN is labelled as such:
Does the number have a total of 9 digits?
Is the number preceded by a string which includes “Social Security” or “SSN” Proper Names

Proper names take the form first name, middle name or initial, last name, such as John T. Smith.

Rule 1:

Is there a capitalized string followed by another capitalized string ( . . . John Smith . . . ).

If so, the two capitalized strings will be automatically selected for encryption.

Rule 2:

Any grammar or syntax rule or sentence construction that usually has a proper noun precede or follow a certain word or phrase such as “Smith said . . . ” or “ . . . was sent to Smith” will have the proper noun automatically selected for encryption.
   Rule 3:
Any word or phrase which is not found in the dictionary as a common word in the English language will be assumed to be a proper noun and automatically selected for encryption.
   Rule 4:
Any usage of a common title or prefix such as Mr., Mrs., Ms., named, given name, family name, middle name, etc. followed by a capitalized string will have the capitalized string automatically selected for encryption.
   Rule 5:
Lists having headings such as “name”, “persons”, “members”, “directors”, “shareholders”, etc. or any other common reference that is usually followed by the name of a person.
   Phone Numbers
   Rule 1:
Is the number a numeric string of 7, 10 or 11 digits (or however many digits there are in phone numbers of the country of interest) with spaces, dashes or other filler characters according to set phone number patterns, such as 1-xxx-xxx-xxxx or xxx-xxxx? If so, encrypt the string. Many standard patterns exist for the US, Europe and other countries to identify a phone number in a text document or spreadsheet.
   Rule 2
Is there a 7, 10 or 11 digit string following a string “phone” or “phone number” or “work number” or “home number” or “cell” or “phone #” or “FAX” or “FAX number”, etc? If so, encrypt the numeric string.
   Rule 3
Is there a list withe heading “phone” or “phone number” or “work number” or “home number” or “cell” or “phone #” or “FAX” or “FAX number”, etc. where items in the list are numeric strings having the above defined pattern? If so, encrypt each number in the list.
   Address
   Rule 1:
Is there a numeric string followed by one or more capitalized words with no period between the numeric string and the next capitalized word? If so, encrypt the numeric string and the capitalized words following it.
   Mother's Maiden Name or Other Account Password
   Rule 1:
Is there a string preceded by or nearly preceded by (or followed by) a string “maiden”, “MMN”, “maiden name”, “account password”, “password” or “PSW”? If so, encrypt the string that follows the label (or precedes it).
   Rule 2:
Is there a name detected as a proper name by any one of the preceding Proper Name detection rules? If so, encrypt it.
   Rule 3:
Is there a word which is used in conjunction with account numbers and/or a list of other sensitive information in a list.
   Some of the above rules require a dictionary of sensitive terms to be kept on the client computer or stand alone computer against which terms in the document are to be compared. Some of the rules require checking a grammar checker resource to determine if a word is used as a noun or verb. Others of the rules require patterns of numeric strings such as phone numbers or social security numbers to be recognized. Full dictionaries, grammar checkers and lists of patterns can be kept on the client computer without compromising the security of the information being protected in the document.

As the process is used, it will become easier to identify and code in rules that will more efficiently identify sensitive information within a document. Further, in some embodiments, certain writing conventions such as the use of double quotes ““ . . . ”” around text in a document to be encrypted can be used to automatically trigger a recognition rule to encrypt the text between the double quotes.

For illustration, assume we are trying to capture for encryption a U.S. address buried in a text document. The U.S. address has the specific form 1234 Fifth Street, Los Angeles, Calif. 12345. If we look at the type of text in this sequence, it might be described as: number; capitalized words; city (recognized from city library in dictionary); state (recognized from state library in dictionary); number. A starting set of rules would be:
find all text sequences that have the pattern: number followed by a capitalized word followed by a city recognized from the library of cities in the dictionary followed by a state recognized from the state library of the dictionary followed by any know abbreviation of the United States as recognized from said dictionary followed by a number or followed by just a number or not followed by anything.
There may be blank spaces or punctuation within this sequence but no other text is permitted in the midst of the pattern.

Running these rules against a document would clearly catch the address given above in the example and it also would make an overinclusion error by catching the following item (indicated in bold) in a document discussing the frequency of occurrence of certain street names in American cities: “There are 3456 Fifth Streets. Los Angeles, Calif. 1000 . . . . ”

Further, these rules would make an underinclusion error by not catching the following sensitive information which should be caught and encrypted: “He lives at 1234 Fifth Street in Los Angeles.”

The first error can be dealt with by adding a new rule:
The sequence cannot have any periods in it and the number following the state must be recognized as a valid zip code in a zip code library of said dictionary.

The second example, an underinclusion error, can be dealt with by adding a set of segments that conform to the formula:
sentence including address reference words recognized from the dictionary such as “address”, “lives” or “located” either at the beginning or end of the sentence; number followed by capitalized word or words followed by less than 10 characters excluding periods followed by a city name recognized by the list of cities in the dictionary.
   This more inclusive definition can be added to the rules given above such that any text pattern that trips either rule will be selected for encryption and less formal formulations of address will trigger the encryption process.
   Learning Process to Modify Rules

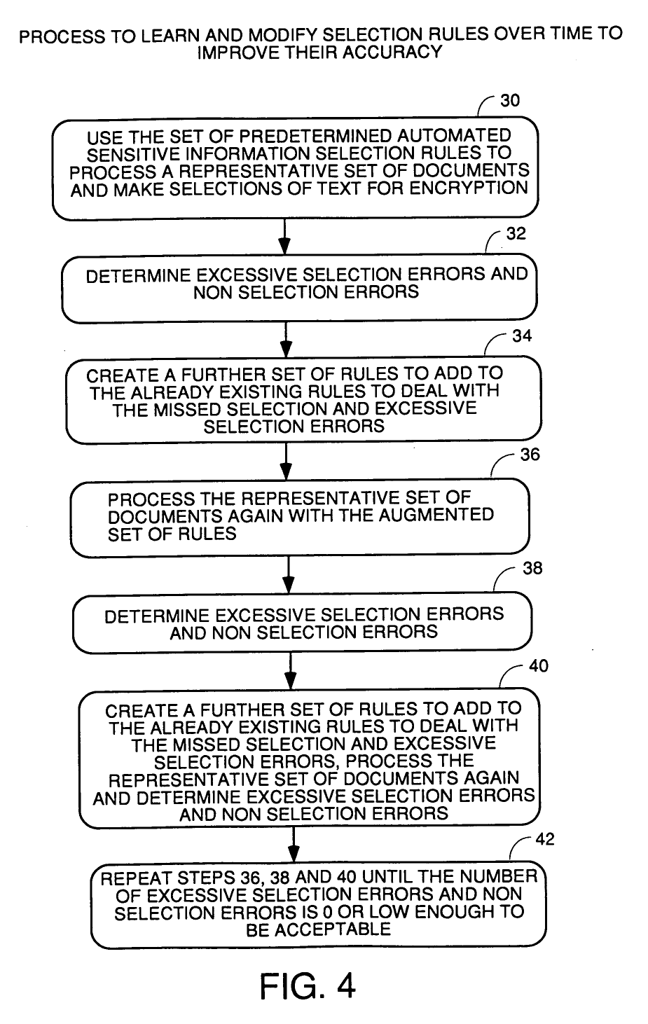

As there are always limitations and errors in any set of rules created for the purpose of selecting text within a document where the text is meant to embody a specific meaning, it is important to have a learning process by which the rules may be modified to improve the accuracy of the recognition and selection process. The process to learn and modify selection rules over time to improve the accuracy of selection is illustrated in the flowchart of FIG. 4. First, a set of sensitive text recognition rules must be written and coded such as the rules defined above. Then, in step 30, the set of predetermined sensitive text recognition rules is used to process a representative set of documents and make selections of text for encryption. It is important for this process to pick a representative set of documents which is a very good representation of the spectrum of documents that will be the bulk of the documents processed by the security application in actual operation.

Step 32 represents the process of determining the errors of selection and non selection. This is done by comparing the text that was selected for encryption by operation of an automatic rule to the actual documents and determining if any text was selected which should not have been. This is a manual step in some embodiments, but in other embodiments, a duplicate set of the documents processed by the automated selection rules are marked by a human operator with some delineators which mark all the sensitive information that should have been selected by the automated rules. No text which is not sensitive text is marked. The duplicate set of documents with the text selected manually is then compared in a computer process to the automatically selected text to determine the missed selection errors and the excessive selection errors. Missed selection errors are sensitive text that should have been selected by the automated selection rules but were not. Excessive selection errors are text items which were selected for encryption but which were not selected by the automated encryption rules.

Step 34 represents the process of creating an additional set of automated selection rules to add to the set of rules used to process the documents previously. The purpose of these additional rules it to deal with the missed selection and excessive selection errors made by the existing set of rules. The rules are written by a human and coded into code to control a computer to carry out the rules. The representative set of documents is then processed again in step 36 with the augmented set of rules.

In step 38, the excessive selection errors and non selection errors are determined again in any of the ways discussed above with reference to step 32. In step 40, a further set of rules is created to add to the existing set of rules to handle the new excessive selection errors and the missed selection errors. Then, the representative set of documents is processed again, and the excessive selection and non-selection errors are determined again. The process of steps 36, 38 and 40 are repeated until the number of excessive selection errors and non selection errors is zero or low enough to be acceptable, as symbolized by step 42.

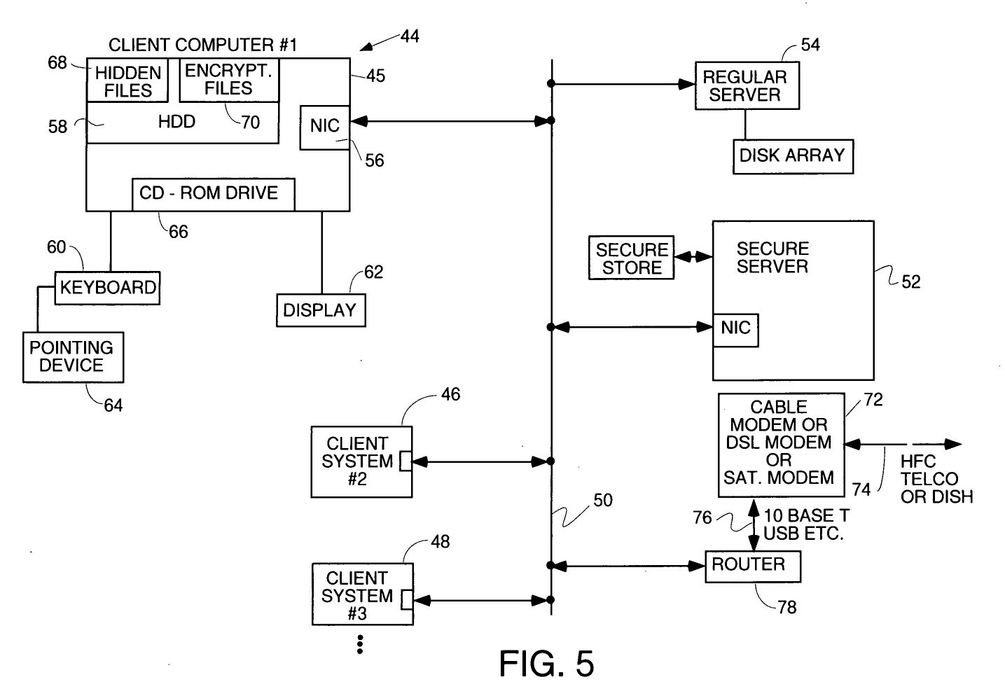

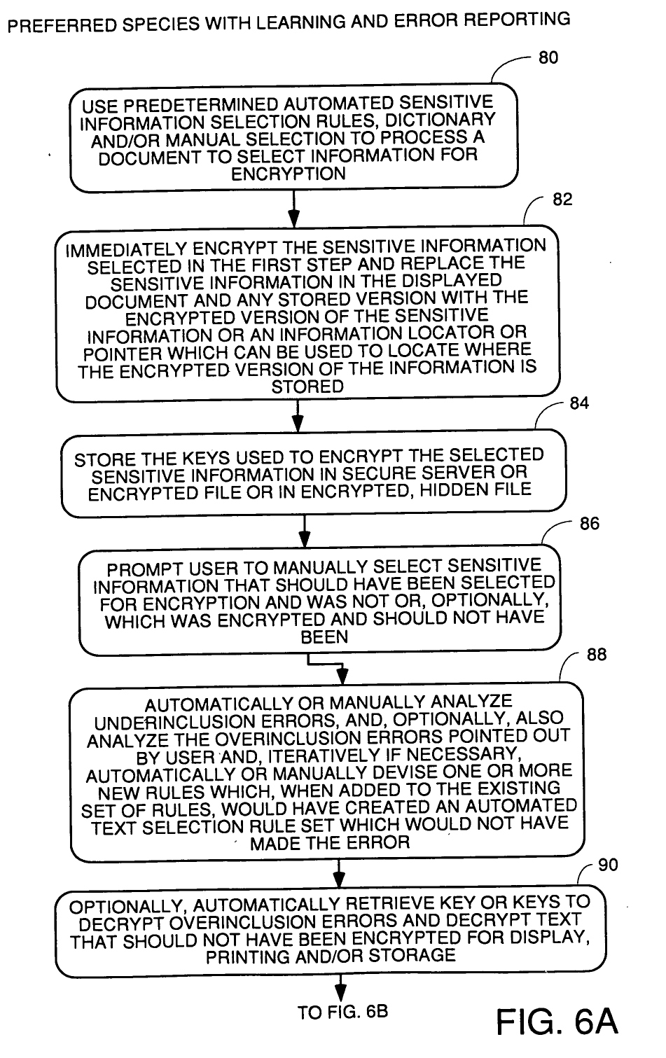

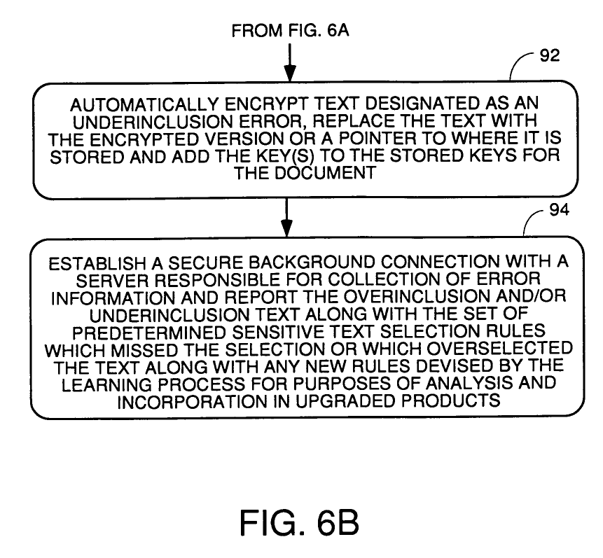

Typically, this learning process goes on in the background for upgrade products. In other words, the process will have tools or menu commands that the user can invoke when an error of inclusion or an error of omission is noted, and the user corrects it. In some embodiments, the security application will automatically generate one or more new rules and/or dictionary entries which would correct the error pointed out by the user and add the new rule(s) and/or dictionary entry or entries to the existing rule set and/or dictionary. In other embodiments, the security application will also have an internet client application that makes an error report in the background to the assignee that includes information about the error that can be used by the assignee to add new automatic recognition rules or modify existing automatic recognition rules to correct the error in upgrade products or adds the new rule(s) and/or dictionary entries to the existing rule set/dictionary by a subsequent download. This preferred embodiment is illustrated in FIGS. 5 and 6. FIG. 5 is a hardware block diagram that illustrates a typical installation in which the partial encryption or partial redaction processes are practiced. FIG. 6 is a flow diagram of the preferred species that includes a learning process and an automatic error reporting process.

Referring to FIG. 5, three typical client computer systems 44, 46 and 48 are shown coupled to a secure server 52 and a regular server 54 via a local area network 50. Each client system is comprised of a computer 45, a keyboard 60 or any other means for manually entering numbers and letters and punctuation and control codes, a pointing devices 64 such as a mouse, touchpad or touchscreen, a display 62, a hard disk 58 which may have hidden files 68 and encrypted files 70, and the client system may also have a CD-ROM drive 66 for reading in documents stored on CD-ROM. Each client computer also has a network interface card or NIC as does each of the servers. Optionally, the system may be connected to the internet or other wide area network via a cable modem, DSL modem or satellite modem 72 and transmission medium 74. The modem is coupled to the LAN 50 through a 10BaseT or USB, etc. link 76 to a router 78 which is coupled to the LAN. This router gives each client an IP address or a local address which is translated to a globally unique IP address in a Network Address Translation process in the router or another circuit which is not part of the router (not shown). This is only necessary in embodiments where background error reporting for purposes of improving upgrade products is employed.

Referring to FIG. 6, there is shown a flowchart of the process of the preferred embodiment which uses a learning process to adapt the rules to correct errors and a reporting process to report errors. Step 80 is the use of the predetermined automatic selection rules, a dictionary and/or manual selection rules to process a document to select text for encryption. This recognition and selection step is performed continuously in the background like a spell checker in the illustrated embodiment, but could be performed as a batch process on a plurality of documents or a separate process after a single document is completed in other embodiments.

In step 82, the selected text is encrypted as soon as it is selected, and the sensitive text is replaced immediately in the displayed and stored versions of the document with the encrypted version or a pointer to where the encrypted version is stored. The pointer can be a server ID concatenated with a document ID concatenated with a key ID which identifies the key used to encrypt a particular part of a document. In some embodiments, the same key is used to encrypt every section of sensitive information in the document. In such a case, the pointer is just the server ID and the document ID.

In step 84, the key or keys (some embodiments use only a single key to encrypt every piece of sensitive information in a document) used to encrypt the selected sensitive information are stored in the secure server or in an encrypted file on the client computer or in an encrypted, hidden file on the client computer (or stand alone computer).

In step 86, the learning process starts with the user being prompted to select any sensitive text that was missed or, optionally, to select any encrypted area of the document that should not have been encrypted. The user then drags his mouse (or selects in any other way) over any sensitive information that should have been encrypted and gives an underinclusion error command to indicate to the computer that this text was not selected by any of the automated processes for encryption and should have been. Optionally, user then drags his mouse over encrypted versions of the document that the user knows should not have been selected for encryption and gives an overinclusion error command to signal the computer which text of the document was included for encryption that should not have been.

The process then automatically analyzes the underinclusion errors in step 88. In some embodiments, overinclusion errors are also automatically or manually analyzed. The learning process then automatically, or manually in some embodiments, devises new rules (or modifies existing rules) and/or dictionary that, if used originally, would have resulted in a set of rules which would not have made the underinclusion (and, optionally, the overinclusion) errors. In alternative embodiments, the underinclusion errors (and, optionally, the overinclusion errors) are analyzed manually by the operator of the client system, and the new rules or modifications of the preexisting rules and/or dictionary is done manually.

In optional step 90, the key or keys needed to decrypt any overinclusion errors are automatically retrieved and the overincluded text is decrypted and re-displayed and stored in the clear in any stored version of the document.

In step 92, the text which was manually selected and indicated as an underinclusion error is automatically encrypted and replaced with the encrypted version thereof or a pointer to where the encrypted version of the text is stored. The key or keys used to encrypt the one or more segments of underincluded text is then automatically added to the set of stored keys for the document.

In step 94, a secure background connection such as an https protocol connection is established between the process of FIG. 6 and a server which is responsible for collecting error reports. This is done using router 78 and cable modem 72 to automatically access the internet or some other wide area network and address packets containing the error report to the error report collection server. After a connection is set up, the process represented by step 94 reports the text reported by the user as an underinclusion error (and overinclusion errors also, optionally) along with the set of predetermined sensitive text selection rules and/or dictionary which were used and which resulted in the error. Also reported are any new rules devised in step 88 in an attempt to overcome the error. The error report collecting server stores all this information in a database for analysis to develop improvements in upgrade products.

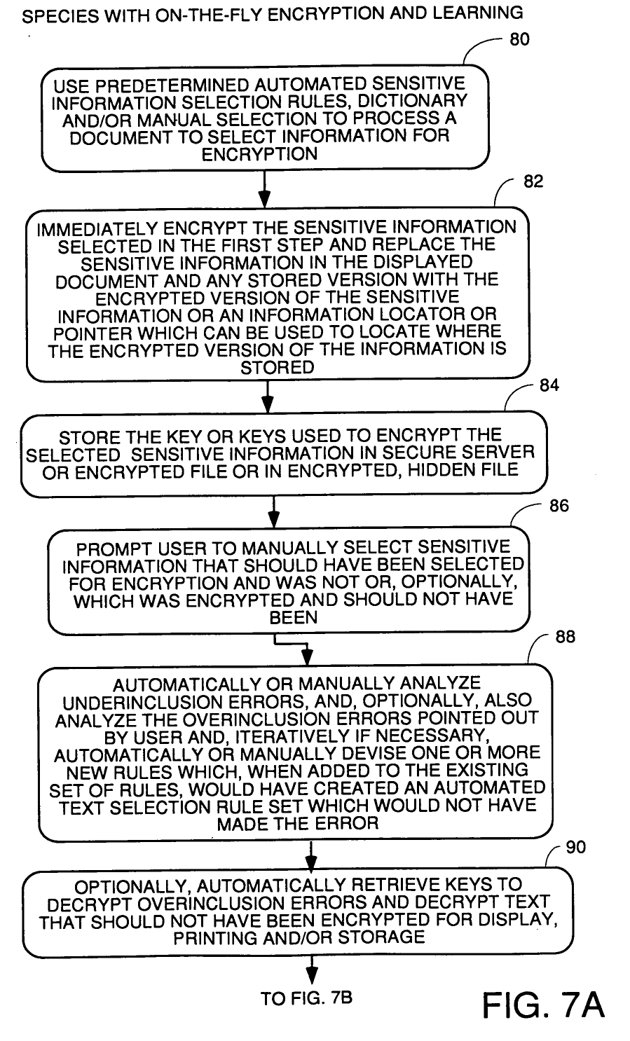

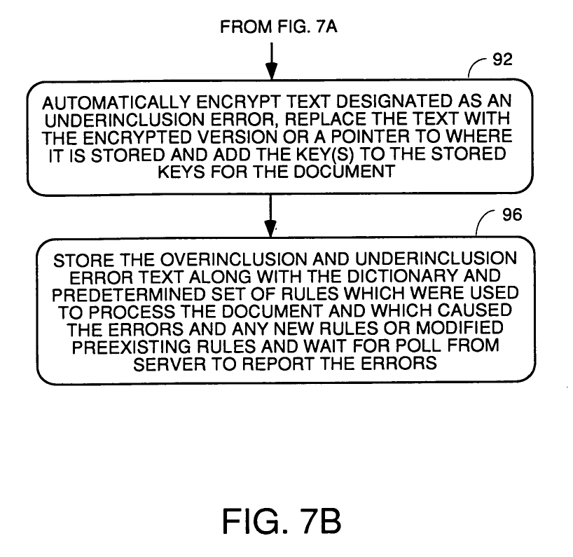

FIG. 7, comprised of FIGS. 7A and 7B, is a flowchart of an alternative embodiment where the client system does on the fly encryption and learning, but does not automatically report errors to a server somewhere, but stores them and waits of a server to ask for them. All the steps 80 through 92 are identical to like numbered steps in the embodiment of FIG. 6. Step 96 is new and represents the process of storing the overinclusion and underinclusion error text along with the dictionary and predetermined set of automatic selection rules which were used to process the document and which caused the error along with any new rule or modification to an existing rule which were devised to fix the error. This information is stored on the client computer which waits for a server at the location of the manufacturer to establish a secure connection to the client computer and ask for the data.

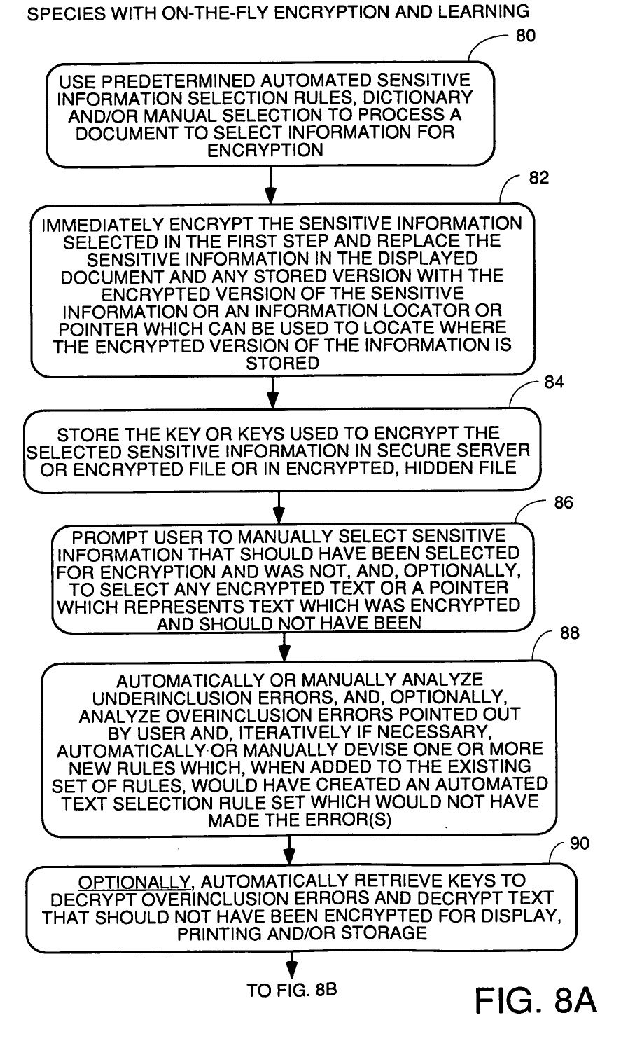

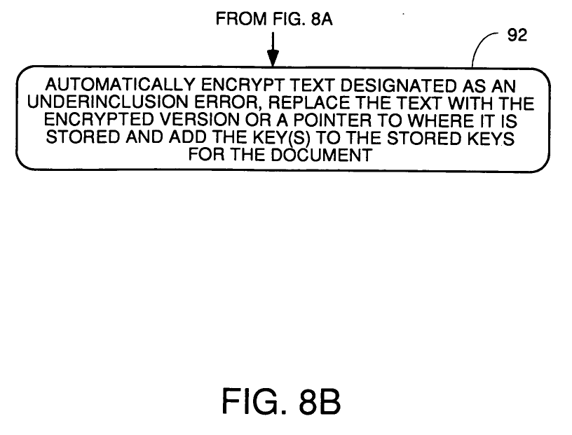

FIG. 8, comprised of FIGS. 8A and 8B, is a flowchart of an alternative embodiment where a client system does on the fly encryption and learning only with no error storage or reporting. All of steps 80 through 84 are identical with the steps previously described with reference to FIG. 6. In step 86 however, the user is prompted to point out underinclusion errors by manually selecting sensitive text which was not selected for encryption but which should have been. In alternative embodiments, the user can also be prompted to point out overinclusion errors by selecting encrypted versions of text or pointers thereto which represent text which was selected and encrypted but which should not have been. Overinclusion errors are not a big problem since the document is already rendered unusable to persons without access to the keys so some additional missing text is not important since it gets restored automatically when an authorized user asks for the document to be restored and is authenticated.

Step 88 automatically or manually analyzes the underinclusion errors and, iteratively, if necessary, automatically or manually devises one or more new selection rules (or modifies existing rules) and/or adds a new dictionary entry which, when added to the automated text selection rules and/or dictionary, would have created an automated text selection rule set and/or dictionary which would not have made the underinclusion error(s). Optionally, overinclusion errors are analyzed also if any are flagged by the user and new rules or modifications to rules are devised to correct the error. Step 90 is an optional step of retrieving the key or keys used to encrypt the overinclusion errors and decrypting the overinclusions and re-display of the decrypted text and storing the decrypted text in any stored version of the document. In step 92, the text which was manually selected and signalled by the user to be an underinclusion error is automatically encrypted and replaced with the encrypted version or a pointer to where the encrypted version of the text is stored and the key or keys used to encrypt the underinclusion error text is added to the store of key or keys used to encrypt the other pieces of sensitive information in the document.

Generic Document Protection Process

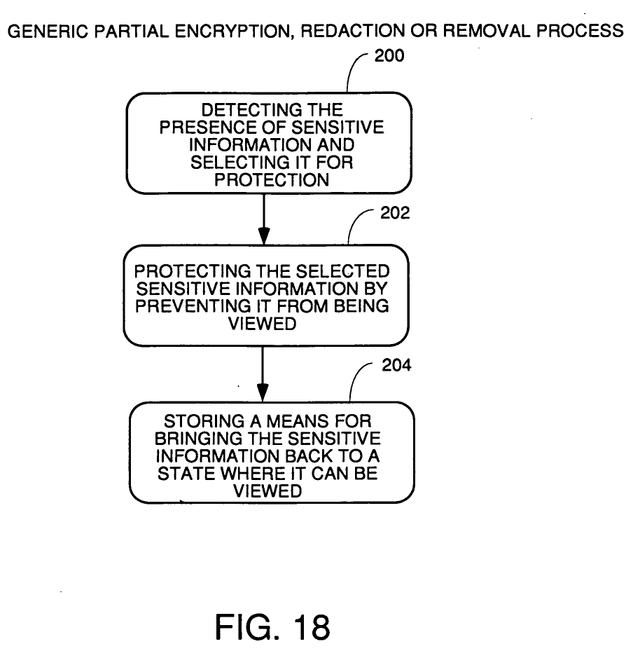

Referring to FIG. 18, there is shown a flow chart of a genus of processes to protect sensitive information in documents by partial encryption, partial redaction or partial removal of the sensitive information. Step 200 represents the process of recognizing sensitive information in any document in any way and selecting it for protection. Step 202 represents the process of protecting the selected sensitive information from view in any way. Step 204 represents the process of storing a means for bringing the protected sensitive information back to a readable state.

The recognition part of step 200 can be done in any way discussed elsewhere herein such as using dictionaries, rules of selection etc. Once particularly useful application of the process of FIG. 18 is to go into an email archive folder or inbox folder or sent mail folder and automatically detect sensitive text segments in emails and/or attachments and mark them for protection. The marked segments are then be encrypted, redacted or removed in step 202. In these embodiments to protect received and archived mail and sent mail, the document protection function is integrated into an email client like Microsoft Outlook and runs in the background to open emails and attachments in the various folders with an HTML editor, save them as Word or other files which can be edited if they cannot be edited when first opened by the HTML editor, open the editable email or attachment if it had to be saved by the HTML editor to make it editable, detect sensitive information automatically, mark that information for protection, protect that marked text in any of the ways described elsewhere herein and save the protected file by writing over the original unprotected email or attachment in the file where it was found. Steps 200, 202 and 204 should be interpreted for purposes of the claims as covering all these alternative embodiments.

The keys to decrypt encrypted segments of emails and attachments or other documents can be sent in a separate file that is secure with the email or in a separate email. These keys can also be stored on a secure FTP or other server and the recipient can retrieve them when it is time to restore the email message and/or attachment to its original condition. The same is true for redacted or removal embodiments for emails, attachments or other documents. The original text can be sent in a file with the email or separately in a different message or the original text segments can be stored on a secure server and retrieved by the recipient using the pointers in the document. Step 202 should be interpreted to cover all these different embodiments.

One way not discussed at length elsewhere herein is the use of multiple dictionaries, each of which contains words or phrases which may be generic or which are specific to a particular field of endeavor. In the preferred embodiment, the specific dictionaries can be turned on or turned off by the user based upon the task the user is carrying out.

In other embodiments, the dictionaries are all searched either simultaneously or one at a time to make a determination whether a particular work or pattern of characters or phrase is a piece of sensitive information.

Another way of finding sensitive information is to do either or both of the following things: 1) search one or more dictionaries; 2) compare text to rules which define patterns of characters that are likely to be sensitive information such as addresses, phone numbers, social security numbers, names, bank account numbers, credit card numbers, etc.

An alternative embodiment is to use a set of rules to recognize phone numbers, names, addresses, social security numbers, credit card numbers, bank account numbers etc. and to provide a user interface to enable the user to selectively turn on or turn off one or more rules or entire levels of subsections of rules.

Step 202 to protect the selected sensitive information can be accomplished by partial encryption, partial redaction or removal of the sensitive information and storing it elsewhere in a secure location as detailed in the descriptions of other embodiments herein.

Step 204 can be accomplished in various ways depending upon the manner in which the sensitive information is protected. If the sensitive information is partially encrypted, storing the means of bringing the sensitive information back into view comprises storing the decryption key in a secure location and storing a pointer in the document to point to the decryption key. If the sensitive information is redacted or the sensitive information is removed from the document altogether, step 204 comprises storing a pointer where the original sensitive information can be retrieved from the secure storage and inserted back into the document in the right place. The removed information need not be encrypted, but it should be stored somewhere outside the document to be protected and a pointer to it substituted in the document.

Generic Document Protection Processing with Premarking and Manual Approval and Marking

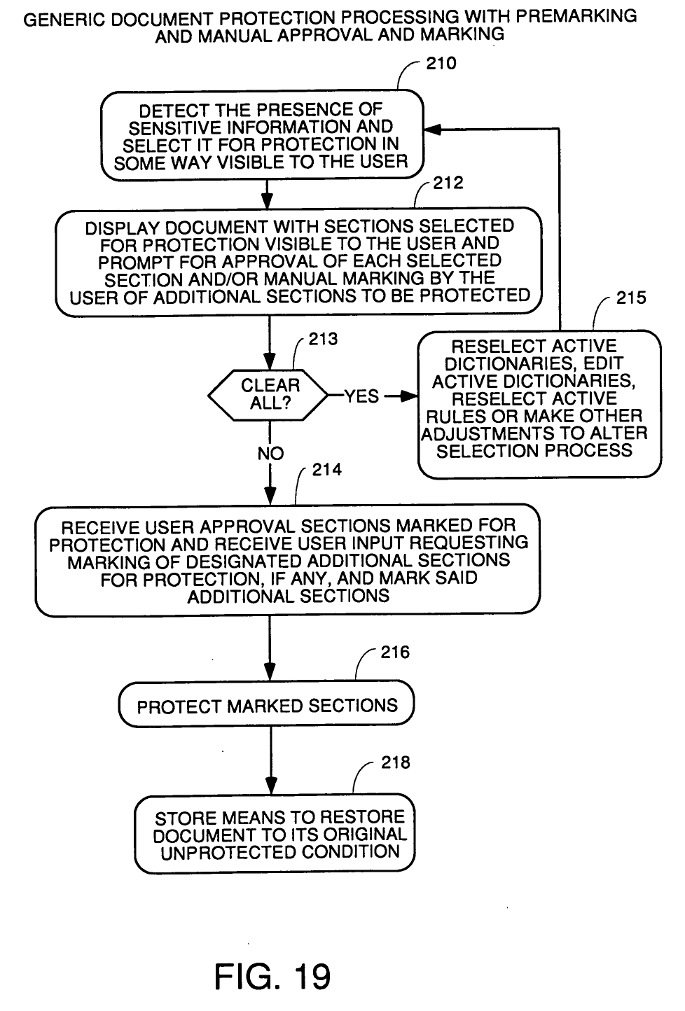

Referring to FIG. 19, there is shown a flow diagram of an embodiment which requires manual approval of the manual selections of sensitive information before that sensitive information is protected by partial encryption, redaction or removal. Step 210 detects the presence of sensitive information using any of the methods described herein including using one or more dictionaries (which is some embodiments can be individually enabled and disabled by the user for the search), rules defining patterns for sensitive information (such as addresses, phone numbers, social security numbers—said rules being selectively enabled by the user so that individual rules or sections of rules can be turned off or on for the search. Selection can be by comparison of the text of a document or email to be protected against a collection of terms, numbers, phrases, etc. gathered from learning activities carried out by the computer as the operator manually makes selections of sensitive information in other documents or the same document for protection.

Step 212 represents the process of displaying the document for approval of the selections made automatically by the computer with those selections being highlighted for review by the operator. In some embodiments, the computer prompts the user to approve each selection and in other embodiments, the user just selects selections he or she does not want encrypted, redacted or removed and gives a command to deselect or finds other text etc. that should have been selected and was not and highlights that text and gives a command to add it to the list of things to be protected. In some embodiments, the computer learns from these selections and deselections and puts together a table or database of sensitive information that the computer automatically selected and the user agreed with along with the text of other selections made manually by the user.

In some embodiments, step 212 is followed automatically by step 214, but in other embodiments, step 212 is followed by a step 213 which displays a query to the user as to whether the user wants to clear all automatically made selections and start again. If a choice to clear all automatically made selections is received, step 215 is performed to change the means by which the automatic selections are made so the same results do not occur on the next iteration. In step 215, in the preferred version of this embodiment, the user is given the user interface tools to reselect the active dictionary or dictionaries in use, edit the active dictionaries to remove or deactivate certain words or phrases so they cannot be used for automated selections or to add words or phrases to be used to make automated selections, reselect which rules for automatic recognition of sensitive information are active or make other adjustments to alter the selection process. In an alternative version of this embodiment, step 215 is limited to the system administrator's choices as only the system administrator has privileges set to be able to change the active dictionaries, edit the dictionaries or change or edit the active rules used for automatic selection.

Processing then proceeds back to step 210 to make automatic recognition and selection of sensitive information again.

If the user chooses to not clear all automatic selections, step 214 is performed. Step 214 represents the process of receiving user approval of automatic selections and receiving user input requesting marking for protection of other text that was not automatically selected and so marking the text etc.

Step 216 represents the process of protecting the final list of marked sections by partial encryption, redaction or removal. This can be done upon receiving a specific command from the user or when the document is closed.

Step 218 represents the process of storing the means to restore the document to its original condition such as by storing decryption keys for the encrypted segements and pointers to the keys or storing pointers to the original text that was redacted or removed.

This embodiment is especially useful when document processing is not being outsourced for processing. When documents containing sensitive information are being processed by outside contractors, there is a need to not allow the outside contractors to be able to view sensitive information. When outside contractors are involved, the embodiments herein with run in background to immediately recognize sensitive information as soon as it is entered and encrypt, redact or remove it from the document are the most useful. That however can lead to automatic protection of information that is not sensitive or no protection of information that is sensitive since the dictionaries and rules are fallible and can miss sensitive information or include information which is not sensitive. Therefore, this embodiment which presents all text selected for protection for review and approval is a better embodiment where outside contractors are not involved and the user who has privileges to return the document to its original state prefers not to have to give the extra commands to do that just to verify that all protected segments were properly selected. In this embodiment, he or she can verify that fact and pick additional segments for protection before the selected information is encrypted, redacted or removed.

Sensitive Segment Simple Removal Embodiments

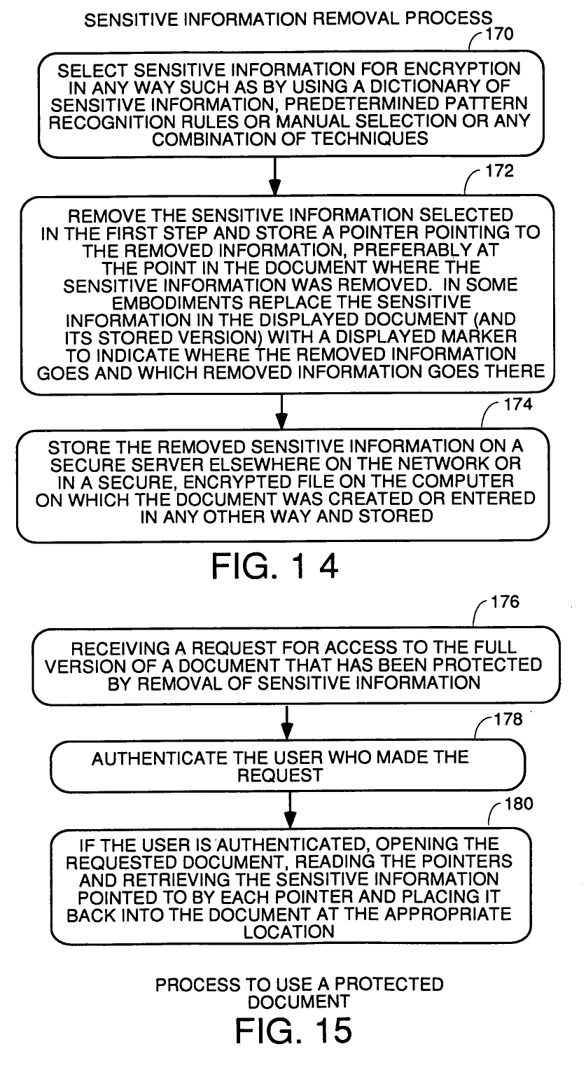

There is a simple class of embodiments not requiring partial encryption or partial redaction, and using removal of the sensitive information from the document to be protected. This simple embodiment has the advantage that no encryption is performed so the complexity of the encryption process, storing the keys and being able to retrieve them is eliminated. There is much encryption software available to protect entire documents, but because of the hassle of maintaining records of the keys and the need to decrypt the documents, this software is not in wide use. FIG. 14 is a flowchart of the process to create a protected document with sensitive information removed. FIG. 15 is a flowchart of the process to use the protected document. Both FIGS. 14 and 15 also symbolize embodiments where partial encryption or partial redaction of the sensitive information is used instead of removal if the removal step is replaced with a partial encryption or partial redaction step. Step 170 represents the process of selecting the sensitive information to be removed (or encrypted or redacted). This can be done using one or more dictionaries of sensitive terms, names, addresses, phone numbers, social security numbers, etc. It can also be done using predetermined pattern recognition rules or by pattern recognition rules of patterns that have been learned from observing manual selections of sensitive information performed by human operators. It can also be done by manual selection except in partial redaction embodiments where manual selection of the sensitive information is in the prior art. It can be done in any combination of these ways or by any other way which results in sufficient reliability of selection of sensitive information.

Step 172 represents the process of removing the sensitive information selected in step 170 and storing a pointer which points to the removed information. In the preferred embodiment, this pointer is stored in the document (either visibly or not visibly) at the location where the sensitive information was removed. This can be done immediately in some embodiments, and, in other embodiments, is done after a short predetermined or programmable delay or only upon receiving a command from the user. In some embodiments, only an non displayed pointer is put in the document to point to which removed information belongs at the location of the pointer. In other embodiments, a displayed marker is substituted for the removed information to indicate that information has been removed at the location where the marker is displayed. The marker serves as a pointer or link to the particular sensitive information that has been removed so that the complete document can be reassembled when needed.

In step 174, the removed sensitive information is stored on a secure server elsewhere on the network or in a secure file such as an encrypted file on the same computer which stores the document which has been protected.

Partial Encryption or Partial Redaction or Removal of Sensitive Information using an Application Working Directly on Documents Themselves

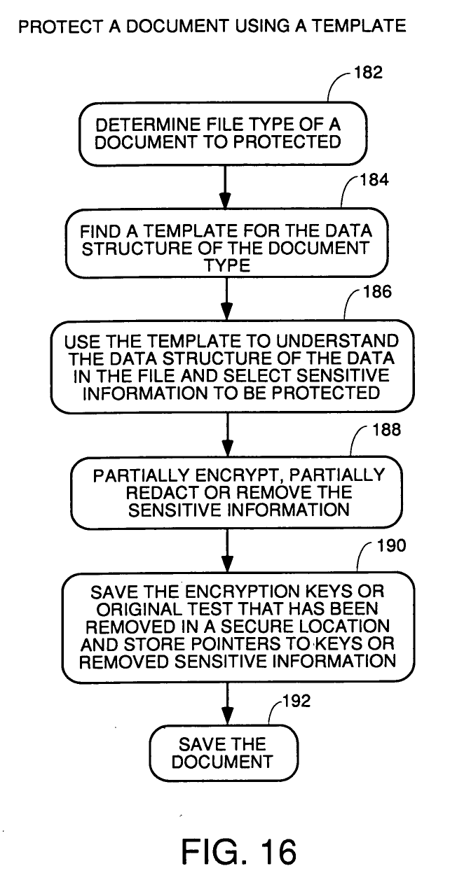

It is not necessary in every embodiment to open a document and protect it by partial encryption or partial redaction or partial removal as a function or object in some other host application such as Word. In the embodiments discussed in this section, a stand alone partial encryption or partial redaction or partial removal application program works on documents without the involvement of another application program. The term document as used above includes all forms of documents as defined for this term in the summary of the invention including word processing documents, emails, databases, spreadsheets, etc. created and stored by other applications. In these embodiments, computer instructions control a computer to perform the process detailed in the flowchart of FIG. 16.

Step 182 represents the process of determine what the file type is of the document to be protected. The file type can usually be determined from the extension or other attributes or properties in the operating system or file system data about the file.

Each file created by a particular application program has a data structure in terms of what the various segments of data in the file mean, e.g., names of fields (semantics), data type (integer, floating point, ascii text, etc.) and so on. If the data structure of the file is understood, then data that needs to be protected because it may contain sensitive information can be located in the data structure. Many file types will have templates which define the data structure of files of that type. Step 184 represents the process of finding the appropriate template for the file type.

Once the template is found, step 186 uses the template to understand the data structure and determine where in that data structure sensitive information may be found. Once the areas where possible sensitive information may be are known, the data in those areas is examined in step 186 using dictionaries, rules, patterns, tables of sensitive information learned from observing manual selection by operators, etc., all as previously described, to determine if there is sensitive information there. Step 186 also represents the process of actually selecting the data which is sensitive.

Step 188 represents the process of encrypting or redacting or removing the sensitive information. This can be done in any of the ways described herein.

In step 190, if the sensitive information is encrypted, the keys are stored in a secure location such as a secure server elsewhere on the network or in a secure file stored anywhere. If the data is redacted, the original data before redaction is stored in the secure location or secure file. If the data is to be removed, the sensitive text or numbers are stripped out of the document and stored in a secure location or secure file. Pointers are stored to enable finding the proper decryption key to decrypt any encrypted segment or locate the original text that was redacted or removed altogether so that it can be replaced in the document.

In step 192, the optional step of saving the protected document is performed.

Email Partial Redaction, Partial Encryption or Partial Removal Embodiments using OLE Automation or COM Interfacing

For users of the Microsoft Outlook email client, Microsoft Word is used as a plug in for composing email and viewing incoming email messages. OLE automation or COM interfacing also works to add partial encryption, redaction or removal functionality to protect documents processed in HTML editors or other programs that support COM interfacing. In the case of Word, when a user of Outlook gives a command to compose a new email message, a blank email message form is displayed where the editor is Microsoft Word. This is an example of OLE automation at work where Outlook communicates with objects in Microsoft Word to invoke functionality thereof. Thus, if Word has been modified using Component Object Model (COM) or OLE automation to add the partial redaction or partial encryption or simple sensitive segment removal functionality, the document protection functionality will be available to protect email messages being composed or received email messages, and all the other functionality of Word will also be available to process the document. Typical functionality that is added for the document protection embodiments are the following menu commands: SET MARKER highlights piece of text that has been manually selected for later protection from view; REMOVE MARKER which removes previously designated markers; ENCRYPT which, when invoked, encrypts the marked segments (regardless of whether the marked segments have been manually or automatically marked) of the document being displayed by Word or the host application and storing the decryption key needed to decrypt each segment somewhere outside the document being protected (preferably in a secure store such as a secure key server or a secure file on the same computer which is executing said host application) and storing in the document being protected information sufficient to enable the proper key to be retrieved to decrypt each protected segment of the document; DECRYPT which decrypts the encrypted segments of a partially encrypted document by using the information stored in said document to retrieve each key needed to decrypt an encrypted segment, decrypting the segment and displaying the decrypted text in the location where it was originally existed in the document; AUTOMATED MARKER automatically marks sensitive segments using dictionaries and/or rules (which dictionaries and rules are active for selection is manually configurable through a settings option); CREATE DECRYPT FILE which creates a file which contains keys and segment IDs which is stored in the secure server which may be local or remote (this file allows another user who has suitable privileges who does not share the same secure server on which the decryption keys are stored to import the keys); IMPORT DECRYPT FILE allows a user with suitable access privileges to import the decryption keys needed to decrypt a partially encrypted document; DICTIONARY allows turning on and turning off of various dictionaries and allows editing of dictionaries; EDIT RULE allows selection of one or more automatic selection rules and editing of those rules; and in some embodiments, there is a separate SETTINGS command which allows various dictionaries and rules to be turned on or off.

In alternative embodiments, REDACT and UNREDACT and/or REMOVE and UNREMOVE commands are provided either as an additional set of commands to the ENCRYPT and DECRYPT commands or as an alternative to the ENCRYPT and DECRYPT commands. The REDACT and UNREDACT commands provide means for the user to elect to blacken out or otherwise block from view sensitive segments which have been marked for protection and store the original text elsewhere so that the UNREDACT command can be used to follow pointers stored in the document, retrieve the original text and restore the document to its original condition. The REMOVE and UNREMOVE commands are just like the REDACT and UNREDACT commands except they simply remove the sensitive information from the document and leave a hole in it or a place marker where the sensitive information was along with a pointer to where the original information can be found. The UNREMOVE command follows the pointer information to retrieve the original information and restore it in the document at the place where it was removed.

All these menu commands are implemented through objects which communicate with objects in Word or the operating system to display the menu commands, receive user input and then either carry out the requested functionality or invoke other objects which carry out the requested function. This functionality can be implemented in any host application that processes documents that contain sensitive information needing protection and which supports the COM interface such as HTML editors, Java, Visual Basic, etc.

COM is a standard software architecture based on interfaces that is designed to separate code into self-contained objects or components. Each component exposes a set of interfaces through which all communications to the component is handled. For example, using COM, one can use the Word mail merge feature to generate form letters from data in a database without the user being aware that Word is even involved. Likewise, the mathematical, financial and engineering functions that Excel provides can be used by another application through COM by automating Excel to borrow this functionality and incorporate into another application.

Automation consists of a client and a server. The automation client attaches to the automation server so that it can use the content and functionality that the automation server provides. In the invention at hand, the partial encryption, redaction or removal security program would be an automation client coupled to Microsoft Word as an automation server.

All of the Microsoft Office applications have their own scripting language which can be used to perform tasks within the applications. This scripting language is Microsoft Visual Basic for Applications or VBA. The set of functions that a VBA routine or macro can use to control the application is the same set of functions that the automation client can use to control the application externally. The Office applications provide documentation on their scripting functions in a syntax that is easily interpreted by the VBA programmer.

Microsoft Office applications expose their functionality as a set of programmable objects. Every unit of content and functionality in Office is an object that can be programmatically examined and controlled. A workbook (spreadsheet), document, table, cell and paragraph are all examples of objects which are exposed by Office applications. The objects are arranged hierarchically with the application object being the highest object in the hierarchy.

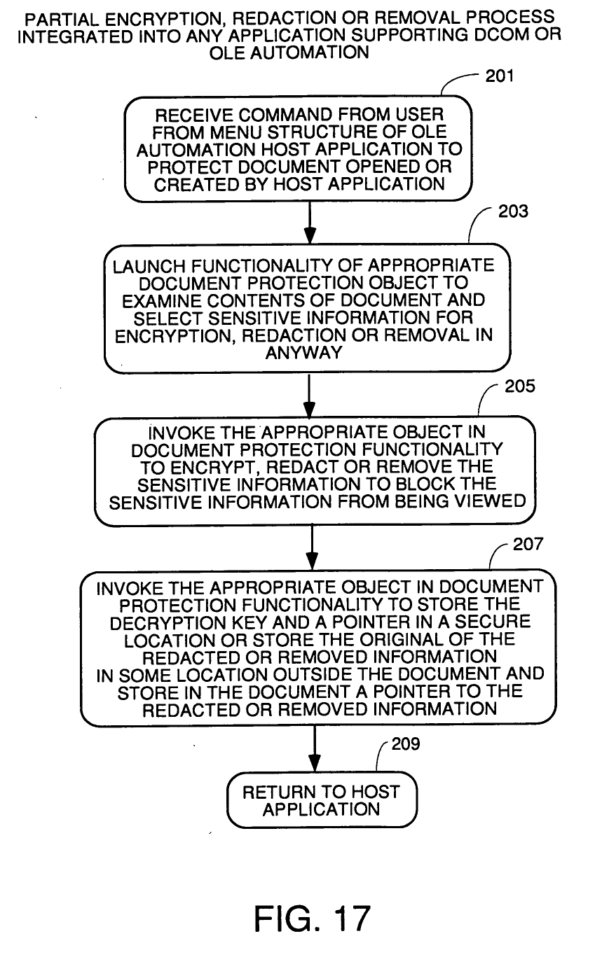

FIG. 17 is an example of an partial encryption or partial redaction or sensitive information removal process which is integrated into any application which supports OLE or COM automation, such as Microsoft Word. The partial encryption or partial redaction or sensitive information removal function can be integrated into Word or any other host application supporting OLE automation or COM interfacing and automation. The functionality to do the partial encrption, partial redaction or partial removal of sensitive information is implemented by one or more document protection objects stored in the computer. These document protection objects communicate with the objects that implement the functionality of the host program through the DCOM or OLE automation interface by making the appropriate function calls to the appropriate host program objects. Hereafter, the partial encryption, partial redaction or sensitive information removal functionality will be called the document protection functionality or document protection objects.

One or more of these document protection objects control said computer to display as part of the user interface of the host application a set of document protection user interface tools necessary to control the document protection process.

The document protection functionality can be invoked by giving an appropriate command from the set of document protection user interface tools after the email message (or any other document) is opened or processing is completed by the host application, as symbolized by step 201. The command received in step 201 is to protect the document. This can be done by partially encrypting it or partially redacting it or by removing the sensitive information and storing it elsewhere to protect the sensitive information from viewing. In some embodiments, there will be several commands to control the document protection process (discussed elsewhere herein) such as SET MARKER, REMOVE MARKER, ENCRYPT, DECRYPT, AUTOMATED MARKER, CREATE DECRYPT FILE, IMPORT DECRYPT FILE, and DICTIONARY.

The document protection functionality comprises one or more library programs and data structures implementing objects which perform the selection and encryption or redaction or removal functions to prevent viewing of the sensitive information. The document protection functionality also saves the decryption keys and pointers to those keys or pointers to the original sensitive infromation that was removed or redacted from the protected document. Step 203 in FIG. 17 represents the process of launching the functionality of the appropriate document protection object in the host application. That object has one or more programs that then execute and scour the document created or opened by the host application for sensitive information to be blocked from view. In some embodiments, this is done automatically and in some it is done manually, and in the preferred embodiment, the user can choose whether it is done manually or automatically.

The finding and selecting of sensitive information can be by use of one or more dictionaries (which in some embodiments can be selectively turned on or off by the user) or through use of rules for comparison to the text to determine if the text pattern matches a pattern of sensitive information detailed in the rule such as phone numbers, social security numbers, addresses, etc.

In some embodiments, the rules and/or dictionaries can be individually turned on or turned off by the user or entire subsets can be turned on or turned off. Any other method of finding and selecting sensitive information discussed for other embodiments can be used also.

Step 205 represents the process of invoking the proper object in the document protection functionality to encrypt, redact or remove the sensitive information selected in step 203 so as to prevent it from being viewed.

Step 207 represents invoking the proper object to in the document protection functionality to store means to enable restoring the document to its original condition. In the case of partial encryption embodiments, this involves storing the decryption key in a secure location and storing in the protected document a pointer to enable location and retrieval of the decryption key. In the case of partial redaction or partial removal embodiments, this involves storing a pointer to the location where the redacted information or removed information can be found. In the partial redaction embodiments and in some of the partial removal embodiments, the location where the redacted or removed information is stored is a secure location. In other partial removal embodiments, the removed characters are stored in the clear in some file outside the document.

In step 209, control is returned to the host application from the document protection functionality.

Protecting Incoming Email using an HTML Editor to Display the Incoming Email

The DCOM or OLE automation process makes the commands necessary to invoke the document protection functionality available in the menu structure of Word or whatever the host application is. All the other conventional functionality of Word or Outlook or whatever the host application is can be used to save the partially encrypted, redacted or sensitive information removed file and transmit it. For example, email client Microsoft Outlook uses Microsoft Word as its editor to compose outgoing emails and display incoming emails. Incoming emails can be displayed in Word by double clicking on the email of interest in the Outlook inbox. This causes Microsoft Word to be launched and the text of the email to be displayed. All the normal functions of Word can then be used. Although the incoming email cannot be edited in the HTML editor window, it can be saved into some folder using the Save As function of the HTML editor, and once saved, it can be edited to remove sensitive information. In this incoming email context, additional email functionality is added to the Word menu structure. For example, when the user double clicks on an email in the inbox, the resulting Word window that opens includes email functions Reply, Reply to All and Forward as additional options which are not available in regular Word menu structures when Word is not being used as an email HTML editor. If the HTML editor has document protection functionality integrated therein through DCOM and OLE automation, when the Reply or Reply To All functions are invoked, the original incoming email is presented in an editing screen and a reply email can be drafted. The document protection functions of the HTML editor can be invoked to select and prevent viewing of sensitive text in the original incoming email or in the reply portion created with the HTML editor such that the sensitive information cannot be viewed. Pointers are stored in the email to point to the appropriate decryption keys on a secure key server or to point to the original text in the case of redaction or removal embodiments.

The protected email can then be sent by invoking the Send function of the HTML editor, and the email will be sent to the incoming mail server of the recipient. The recipient then downloads the email (in the email client case). If the recipient needs to see the full email and has appropriate privileges, he or she logs onto the secure key server and uses the pointers stored in the incoming email to retrieve the appropriate decryption keys or retrieve the original text which has been redacted or removed.

Of course, this same process can be used with any email client and any DCOM linked HTML editor which has document protection functionality integrated therein using DCOM or OLE automation. Outlook and Word are only specific examples.

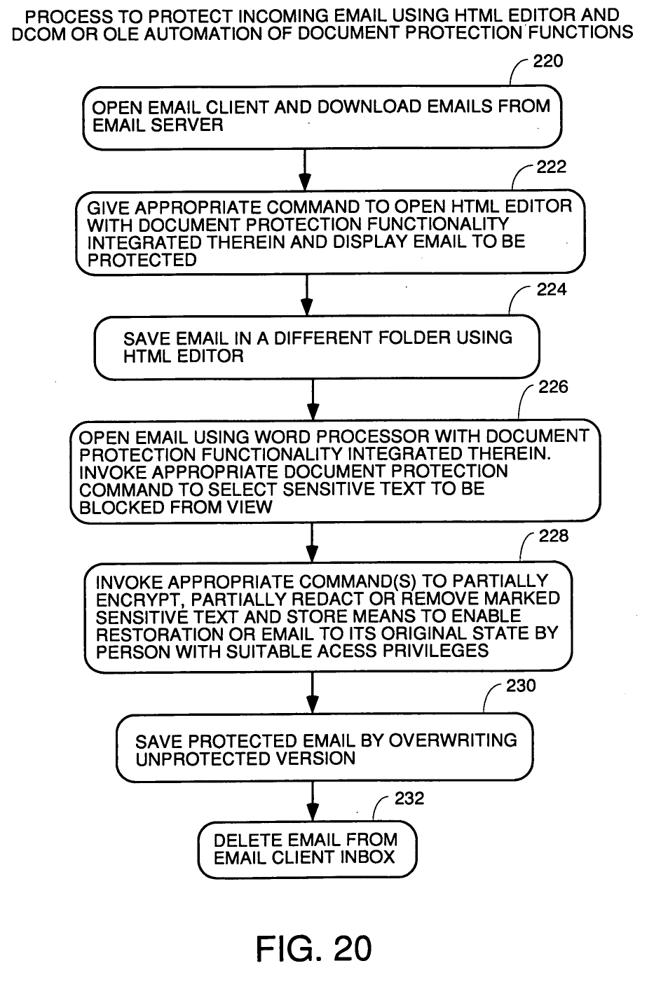

Referring to FIG. 20, there is shown a flowchart of a process to use an Email client with a DCOM linked HTML editor which has document protection functionality integrated therein to protect incoming email. Step 220 represents presenting user interface tools that allow a user to open the email client and downloading emails from the incoming email server as the ISP and receiving user commands that open the email client and download emails. Step 220 also represents the process of the computer logging onto the incoming email server and downloading the emails therefrom and storing the downloaded emails in an inbox of the email client.

In step 222, the appropriate commands are given to open an HTML editor. In the preferred embodiment, the HTML editor has integrated document protection functionality, but in alternative embodiments, no document protection functionality is necessary as long as the saved email can be opened with an application that does have document protection functionality integrated therein. The HTML editor displays the email to be protected. In Outlook, this is done by double clicking on the email in the inbox. The resulting email displayed in the HTML editor (Word) cannot be edited, so it is necessary to use the HTML editor to save the email to a different folder, as represented by step 224.

Step 226 represents the step of opening the email using a word processor or other application that has document protection functionality integrated therein. Step 228 represents the process of invoking the appropriate command(s) to select and mark sensitive text (using dictionaries and/or rules as described in other embodiments described herein) and to encrypt, redact or remove the marked text and replace it with the encrypted text and a pointer to the decryption key or a pointer to where the original text which has been redacted and removed is stored. The terminology “store means to enable restoration of email to its original state” in the claims means storing the encrypted version of the sensitive text along with a pointer to the decryption key or storing a pointer to where the original sensitive text which has been redacted or removed is stored. Typically, the decryption keys are stored in a secure key server and redacted or removed sensitive text is stored in some secure store server elsewhere. However, the keys and sensitive text which has been redacted or removed may also be stored in an encrypted file on the same computer where the document to be protected is stored.

Step 230 represents the process of saving the protected email by writing the protected version over the unprotected version. Finally, for complete security, the original email selected in step 222 is deleted from the email client inbox in step 232.

In some embodiments, all the steps of FIG. 20 are performed manually, and in other embodiments, steps 224, 226, 228, 230 and 232 are performed automatically.

Protecting Email to be Sent

Likewise, when a user wants to send an outgoing email using Outlook, the user clicks on the New icon in the Outlook user interface. This causes Outlook to make function calls through the DCOM interface to Word and open up an HTML editor screen having spaces for the user to enter the recipient's email address, the email addresses of any copy recipients, a subject line and an area in which the main body of the text can be typed. An interface tool such as an icon is also displayed in the HTML editor window by one of the email/HTML objects added to the editor that cooperates with the email client through the APIs and which can be invoked to add an attachment to an email being edited by the HTML editor. A Send command is also displayed in the Word HTML editor window so that the email may be sent via the linked email client such as Outlook once it is composed.

In the specific example discussed herein, Word acts as the editor for composition of the main body of the email and is invoked by the Microsoft Outlook email client.

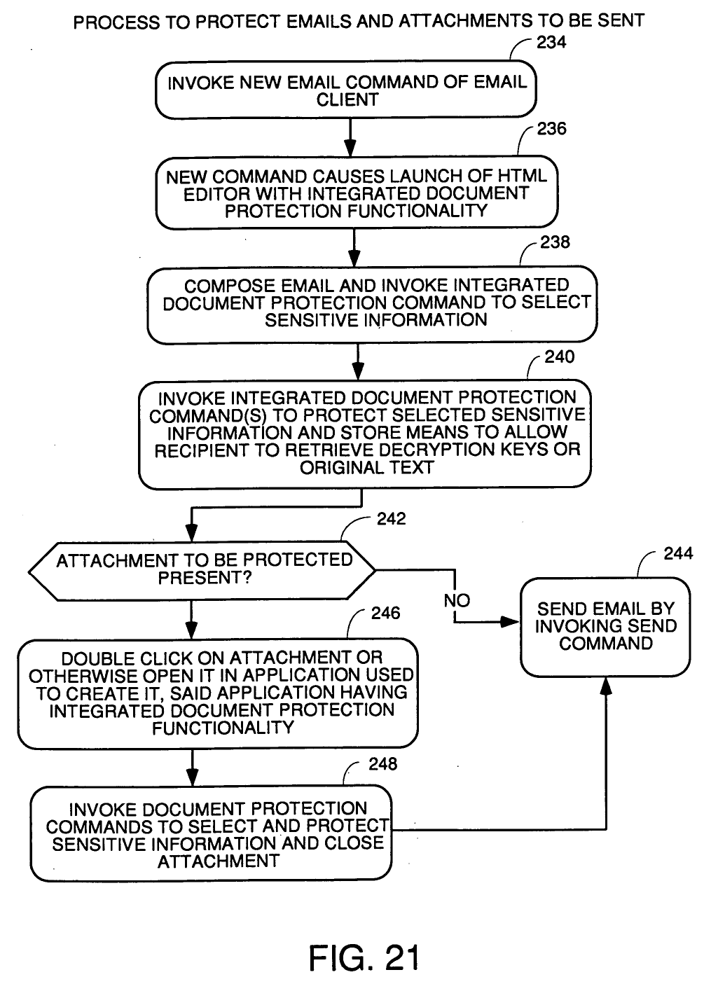

FIG. 21 is a flow diagram of a generic process of how to use an email client with an HTML editor linked to it by DCOM interfacing and which has document protection functionality integrated therein by the DCOM interface to protect outgoing emails and attachments.

Step 234 represents the process of displaying user interface tools which can be invoked to cause an email client to invoke an HTML editor for composition of a new email. Step 234 also represents the process of receiving user input which invokes the compose new email command. This causes the email client to make an API function call to the HTML editor to invoke it to open a compose new email window. The HTML editor will have document protection functionality integrated therein via DCOM or OLE, and user interface tools will be presented in the HTML editor window to allow sensitive text to be selected, marked and protected and, in some embodiments, to manipulate the dictionaries and/or rules used to make the selection and/or edit the dictionaries and/or rules. Step 236 represents the process of launching the HTML editor with integrated document protection functionality and displaying all the user interface tools of the editor and the email functions such as Send and the document protection user interface tools such as Select and Mark and Protect for example.

Step 238 represents receiving user input to compose the email body, addressess, copy recipients, designate attachments, etc. Step 238 also represents the process of receiving user input invoking the document protection tool(s) to select and mark sensitive information in the outgoing email. This causes the HTML editor and computer to invoke the appropriate document protection objects to select and mark. In some embodiments, these tools allow the user to manually select and mark sensitive text, and in other embodiment, these tools allow the user to automatically select and mark sensitive text using one or more dictionaries and/or selection rules. In some embodiments, these tools allow the user to choose between manual or automatic selection. In some embodiments, there are also user interface tools which allow the user to select which dictionaries and/or rules are used and/or edit the dictionaries and/or rules.

Step 240 represents the process of receiving user input via displayed user interface tools to invoke one or more document protection functions to protect the text selected and marked in step 238, and to store means for allowing a recipient of the email to restore the email to its original condition.

There are three embodiments for how the marked text is protected: encryption, redaction or removal. In encryption embodiments, step 240 represents encrypting the marked text and storing the encrypted version where the encrypted text was along with a pointer to the decryption key needed to decrypt the text. The decryption key is then stored in a secure key server in some embodiments. In other embodiments, the secure key server sends a key to use to encrypt each marked text segment and the HTML editor just sends back code to the key server to associate a key with each segment which has been encrypted using that key. In other embodiments, step 240 represents using a key to encrypt each marked segment and storing the key in a secure file and sending that file with the email manually or automatically.

To use the email and restore it to its original form, a user would log into the secure key server, authenticate his identity and have his privileges verified and send the pointers to retrieve the needed keys. The keys would be sent back and used on the recipient's machine to decrypt the encrypted sensitive text segments.

In the redaction embodiments, the marked text is copied to a secure store somewhere and a pointer to it is stored in the email. The copied sensitive text is then redacted in the email so that it is not visible such as by blackening it out. To restore the document to its original form, the user logs onto whatever machine stores the original version of the redacted text and authenticates himself as having privileges to restore the email to its original state. The pointers are then sent and the original text is sent back for insertion into the email at the points where redactions occurred.

In the removal embodiments, the sensitive text which has been marked is simply removed from the document and stored in a secure place. Pointers to the removed text are stored in the document. The recipient of the email can restore it to its original condition by doing the same procedure as for the redaction case.

Step 242 determines if there is an attachment to the email to be protected. If not, step 244 is performed which represents receiving user input invoking the Send command. This causes the appropriate functionality of the email client to be invoked to send the protected email in the normal fashion.

Protecting Attachments to Email to be Sent

An icon is also displayed in the Word HTML compose new mail window to provide a tool by which a user can attach a document to the email to be sent. A similar user interface tool to attach an attachment to an email will be present in any HTML editor. When that icon is clicked, a navigation window opens showing the file system on the computer which the user can browse to drill down to the desired directory and document. When the user browses the file system and finds the file he or she wants attached, the user clicks on the file to select it and clicks on a command called Open (or some similar command in other HTML editors). This causes the selected file to be attached to the email being composed and to have its file name displayed in an attachments line that shows up on the display of the file composition window. When the name of the attachment is double clicked, the attachment is opened in whatever application was used to create it. If the attachment was created in Word, it is opened in Word, and the document protection menu options integrated into Word via the DCOM interface will be displayed in the Word user interface. Thus, the document protection functionality can be invoked through a user interface displayed in Word to partially encrypt, partially redact or remove sensitive information in the attachment before it is sent with the email. Any changes made using the regular Word editing commands or the document protection commands integrated into Word will be saved in the attachment prior to its being sent. In this way, sensitive information in documents to be sent over the internet can be safely and easily implemented by integration into Word without having to re-invent the wheel in terms of an editing and word processing package to send emails and receive them. Steps 246 and 248 in FIG. 21 represent this process of opening an attachment to an email and using the integrated document protection functionality of an HTML editor to select, mark and protect sensitive text in the attachment and save the protected attachment as the attachment that goes out with the email. In some embodiments, the user must double click on the attachment to manually start the process of protecting the attachment. In other embodiments, the attachment will be automatically opened and protected automatically using dictionaries and/or rules and closed. In some embodiments, the automatically selected and marked text in an attachment will be displayed for user final approval before the attachment is closed.

Thus, when the document protection application is integrated with Word it can protect both regular documents and emails. For example, the document protection commands integrated into the Word user interface can be used to protect documents opened and created with Word while using Word in its normal word processing mode. These same commands will be visible in the user interface of Word to protect sensitive information in incoming emails that have been opened up in Word by Outlook and well as outgoing emails being composed in Word for sending by Outlook.

Partial encryption or partial redaction functionality can be implemented in email clients or web browswers using identical selection techniques to select sensitive information for encryption or redaction as were described above for security applications that are integrated into Word or some other program using the COM software architecture. For example, one or more dictionarys can be used. One dictionary may record every name of a resident of the United States and another dictionary may record every known address of a resident of the United States. Another dictionary can record technical terms. Another dictionary might record every known social security number of a citizen of the United States.

Rules sets can also be used to automatically recognize sensitive information such as social security numbers, phone numbers, names, addresses, income levels, etc. In the email embodiments as well as the non email embodiments, the reason rules are used is to make dictionaries easier to manage. By developing rules which can recognize names, phone numbers, social security numbers, addresses, etc. it is possible to eliminate the need to have a dictionary that stores every name in the US or every phone number in the US and have to compare every word or phrase in a document to every entry in every dictionary.

A learning process to develop a table or database of sensitive information from observing an operator manually select sensitive information for encryption or redaction. In this process, each time an operator selects a particular segment of text for encryption or redaction, that element of text is added to a database or table of sensitive information. After having observed an operator manually encrypt or redact enough documents for the table or database to be adequate, the table or database can thereafter be used to compare against words and phrases in outgoing emails being composed or incoming emails being viewed so as to partially encrypt or redact sensitive information before the email is sent or stored in an incoming email archive.

The selection process can be done using dictionaries alone or rules alone or a learned dictionary alone, or, preferably, a combination of all of these techniques or any subcombination.

Web Mail Protection

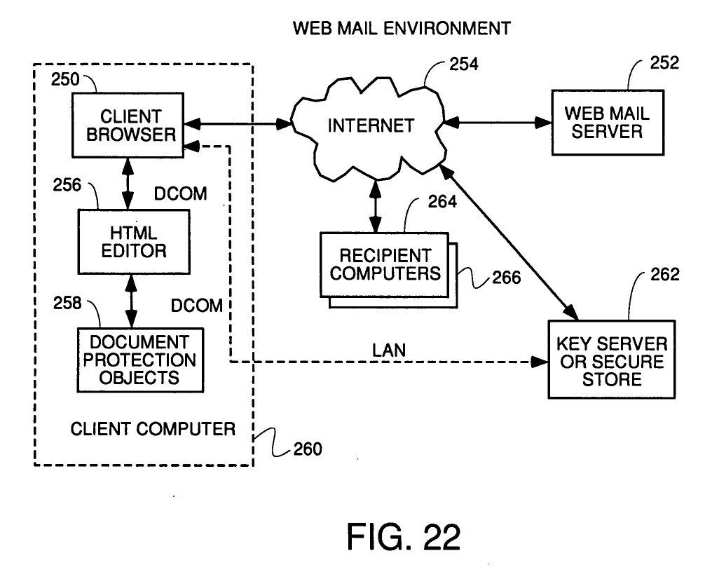

Referring to FIG. 22, there is shown a typical computing environment in which web mail protection of sensitive information can be practiced. In web mail, a client browser 250 logs onto a web mail server 252 through the internet 254 and sends and views email messages. In the environment shown in FIG. 22, the browser 250 is integrated through DCOM to an HTML editor 256 which is integrated through DCOM with document protection objects 258. These document protection objects provide at least the select, mark and protect functionality for the HTML editor 256 as previously discussed for HTML editors in non web mail embodiments.

The web mail server contains programs which control it to receive HTTP request messages from browsers, and then send commands and data back to the user of the browser to cause the client computer to render a log on screen to authenticate the user and, once the user has logged on correctly, to render a user interface on the display of client computer 260.

A key server/secure store 262 stores decryption keys for embodiments where encryption of sensitive information is used and stores the original text in embodiments where the sensitive text in a document is redacted or removed.

Recipient computers 264 and 266 are coupled to the client browser 250 through the internet 254. The users of these computers receive protected emails generated by the client browser 250.

Process to Protect Outgoing Web Mail

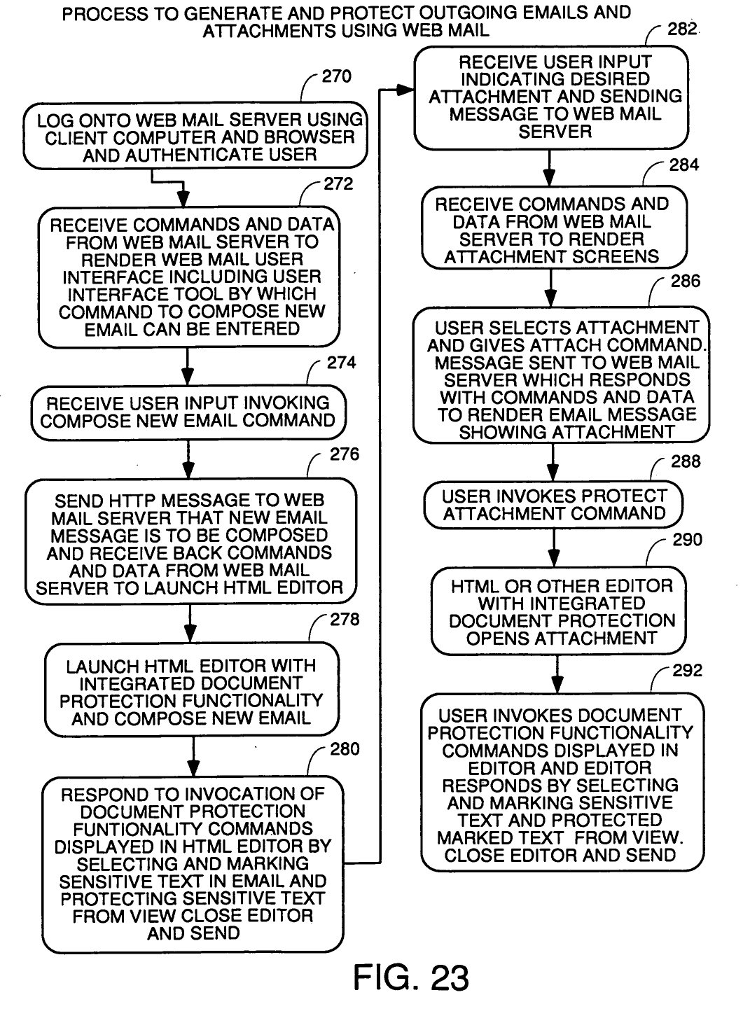

The process of generating a protected email and/or protected attachment using web mail is detailed in the flowchart of FIG. 23. Step 270 represents the process of logging onto a web mail server using client computer 260 and client browser 250 and authenticating the user in conventional fashion. In step 272, after log on, web mail server 252 sends commands and data to browser 250 to cause it to render a web mail user interface screen including user interface tools. These user interface tools include commands to compose new mail, get email, search mail, go to an address book, etc.

Step 274 represents the process in the client computer 260 of receiving user input invoking the compose new email command. This causes browser 250 to send a message to web mail server 252 telling it that the user wants to compose a new email. This causes the web mail server to respond by sending commands and data that cause the browser 250 to render a compose new email display window with spaces to enter the recipient's email address, the subject, a space for the main body of the text of the email and other links or commands that can be invoked to add copy or blind copy recipients or to attach files. When each command is given, for example, to add a copy recipient, the compose mail screen is changed to add a space to enter the email address of a copy recipient. When the user invokes the attach files command, the display is changed to give one or more spaces to name the file to be attached and a browse button, which when invoked, opens a navigation window into the file sytem of the client computer 260 where the user can navigate through the file system directory tree and find the file to be attached. All this is conventional so far.

Step 276 represents the process of the b browser 250 sending a message to the web mail server 252 indicating the user wants to compose a new email message. The web mail server responds by sending back commands and data to launch an HTML editor. The HTML editor can be the browser itself or a word processing program such as Word which is linked to the browser through a DCOM or OLE automation interface. In FIG. 22, the HTML editor 256 is shown as a separate entity such as Word, and is linked to the browser 250 by the DCOM interface. However, in some embodiments, the HTML editor can be the same software entity as browser 250. Whatever the HTML editor is, it preferably has document protection objects linked thereto by the DCOM interface which provides functionality to at least select sensitive text, mark it and protect it. Those linked document protection objects are shown as a separate software entity 258 in FIG. 22.

Step 278 represents the process of launching the HTML editor with integrated document protection functionality. If the HTML editor is a separate entity, then this step is literally the sending of the appropriate messages through the DCOM interface to launch the editor. If the HTML editor is the browser itself, step 278 may only be a step of invoking the appropriate document protection objects to cause display of the document protection commands in some embodiments, but in other embodiments where the document protection commands are already displayed, step 278 is not necessary as the browser with integrated document protection functionality is already launched.

Step 280 represents the process of receiving user input which invokes document protection commands to select sensitive text, mark it for protection and protecting it and responding by invoking the appropriate document protection objects to carry out the requested operation. Selection can be manual or automatic. Protection can be by encryption, redaction or removal of sensitive text from the body of the email in any of the ways described elsewhere herein. Step 280 represents the completion of the process of protecting the main body of the email, and if there are not attachments or none needing protection, the email can now be sent by invoking the send command displayed on the email composition window.

The process of protecting any attachment starts in step 282 by receipt of user input indicating that the user wishes to attach an attachment. This causes the browser 250 to send a message to the web mail server indicating the desire to attach an attachment. The web mail server responds by sending commands and data to the browser to cause it to render appropriate attachment screens. The attachment screens allow the user to type in the path and name of the file to attach or give a browse command. The browse command causes the browser to render a navigation screen which displays part of the file system and which allows the user to enter input to navigate the file system to find the directory, folder and file desired for attachment. The user then selects the file in step 286 and gives an attach command. This results in a message to the web mail server which responds with commands and data to cause the browser to render a email message window with the composed email and showing the attachment.

Step 288 represents the receipt of user input indicating a desire to protect the attachment in some way, typically by invoking a protect attachment command. However, the desire to protect the attachment may be expressed in some embodiments by the simple acts of opening the attachment with an HTML or other editor program with integrated document functionality commands. Step 290 represents the process of opening the attachment with an HTML editor or other editor with integrated document protection functionality. The editor may be the program which created the attachment such as Word, Word Perfect, Excel, Acrobat, etc. but it should have integrated through the DCOM interface or OLE suitable document protection objects to select and mark sensitive text and protect the marked text.

In step 292, the user invokes the document protection functionality commands of the editor to select and mark sensitive text and protect that text from view by encryption, redaction or removal. These steps can be performed in the manner previously described. The editor is then closed and the attachment is saved over the original so that the attachment with the protected text is sent as opposed to the original.

The protection process for both the email main body and the attachment involves storing the decryption keys in a secure key server and storing pointers to those keys in the attachment or email main body for encryption embodiments or storing the original text in a secure store or secure file and storing pointers to the original text in the document protected for redaction or removal embodiments. In some embodiments, the decryption keys or original text is stored in an encrypted or password protected file which is attached to the email itself.

The recipient receives the protected email and protected attachment and uses the pointers to find the decryption keys or original text and restores the email and/or attachment to its original state.

Although the various species has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A computer-readable medium having stored thereon computer-readable instructions which, when executed by a computer, control said computer to perform the following process:
A) selecting sensitive information to be removed from a document stored in or being processed by a computer, said selection being performed in any one or a combination of ways;
B) removing said sensitive information and storing a pointer pointing to where the removed information is stored;
C) storing said removed sensitive information in a secure manner.

2. The medium of claim 1 wherein said computer-readable instructions include instructions to carry out step B by removing said sensitive information to be performed by storing a pointer to the removed information at a location in the document where the information was removed.

3. The medium of claim 1 wherein said computer-readable instructions include instructions to cause step B to be performed by storing a pointer to the removed information at a location in the document where the information was removed and displaying at said location a marker to indicate information has been removed from the document at that point.

4. The medium of claim 1 wherein said computer-readable instructions include instructions to cause step C to be performed by storing said removed information in a secure server coupled to said computer by a network.

5. The medium of claim 1 wherein said computer-readable instructions include instructions to cause step C to be performed by storing said removed information in a secure file on said computer.

6. A computer-readable medium having stored thereon computer-readable instructions which, when executed by a computer, cause said computer to perform the following process:
receiving a request to have access to the full, unprotected version of a document which has been protected by removal of sensitive information and storing of said sensitive information in a secure manner;
authenticating the user who made the request;
if the user is authenticated, opening the requested document and retrieving the information pointed to by the pointers and placing said sensitive information back into said document at the appropriate location.

7. A process comprising the steps:
A) selecting sensitive information to be removed from a document stored in or being processed by a computer, said selection being performed in any one or a combination of ways;
B) removing said sensitive information and storing a pointer pointing to where the removed information is stored;
C) storing said removed sensitive information in a secure manner.

8. The process of claim 7 wherein step B is includes the step of storing a pointer to the removed information at a location in the document where the information was removed.

9. The process of claim 7 wherein step B includes the steps of storing a pointer to the removed information at a location in the document where the information was removed and displaying at said location a marker to indicate information has been removed from the document at that point.

10. The process of claim 7 wherein step C is performed by storing said removed information in a secure server coupled to said computer by a network.

11. The process of claim 7 wherein step C is performed by storing said removed information in a secure file in the same computer upon which said document is stored or processed.

12. A computer having an operating system and programmed with a program which controls said computer to carry out the following process:
A) selecting sensitive information to be removed from a document stored in or being processed by a computer, said selection being performed in any one or a combination of ways;
B) removing said sensitive information and storing a pointer pointing to where the removed information is stored;
C) storing said removed sensitive information in a secure manner.

13. A computer having an operating system and programmed with a program which controls said computer to allow a user to access the full version of a document which has been protected by removal of sensitive information and storing said removed sensitive information in a secure manner by performing the following process:
receiving a request to have access to the full, unprotected version of a document which has been protected by removal of sensitive information and storing of said sensitive information in a secure manner;
authenticating the user who made the request;
if the user is authenticated, opening the requested document and retrieving the information pointed to by the pointers and placing said sensitive information back into said document at the appropriate location.

14. A computer-readable medium having computer-readable instructions thereon which, when executed by a computer cause said computer to perform the following process:
determining the file type of a document to be protected;
finding a template for the data structure of the document type;
using the template to understand the data structure of the data in said document file and searching said data for sensitive information using any one or more of a plurality of techniques to detect sensitive data and selecting sensitive information;
protecting the sensitive information;
storing pointers to whatever information will need to be retrieved to put the document back into its original condition;
saving the protected document.

15. The medium of claim 14 wherein said instructions include instructions to cause said computer to protect said sensitive information by encrypting each piece of sensitive information and storing pointers by which the key or keys needed to decrypt the sensitive information can be retrieved from a secure file or a secure store.

16. The medium of claim 14 wherein said instructions include instructions to cause said computer to protect said sensitive information by redacting each piece of sensitive information and storing the original text in a secure location and storing pointers by which the original information can be retrieved and be put back into the document in the correct location.

17. The medium of claim 14 wherein said instructions include instructions to cause said computer to protect said sensitive information by removing each piece of sensitive information and storing the original text in a secure location and storing pointers by which the original information can be retrieved and be put back into the document in the correct location.

18. A computer-readable medium having stored thereon computer-readable instructions which, when executed by a computer, control said computer to perform the following process:
A) selecting sensitive information to be protected from view in a document stored in or being processed by a computer, said selection being performed in any one or a combination of ways;
B) protecting said sensitive information from view; and
C) storing a means for bringing said protected sensitive information back to a readable state, said storing of said means being in a secure place.

19. The computer-readable medium of claim 18 wherein said computer-readable instructions are such as to control said computer to use one or more dictionaries for finding sensitive information and for providing user interface tools which allow a user to turn one or more of said dictionaries on or off to limit which dictionaries are searched to find sensitive information.

20. The computer-readable medium of claim 18 wherein said computer-readable instructions are such as to control said computer to simultaneously search one or more dictionaries each of which has different sorts of sensitive information in it to find sensitive information in a document.

21. The computer-readable medium of claim 18 wherein said computer-readable instructions are such as to control said computer to search one or more dictionaries to find sensitive information in a document and/or use rules that define patterns of characters which are likely to be sensitive information.

22. The computer-readable medium of claim 18 wherein said computer-readable instructions are such as to control said computer to search either or both of a set of one or more dictionaries and/or one or more selection rules

23. The computer-readable medium of claim 22 wherein said computer readable instructions are such as to control said computer to provide user interface tools which a user can selectively turn on or off various ones of said one or more dictionaries and to selectively turn on or off one or more of said rules.

24. The computer-readable medium of claim 18 wherein said computer-readable instructions are such as to control said computer to run steps A, B and C automatically in background whenever a document is being created or is opened.

25. The computer-readable medium of claim 18 wherein said computer-readable instructions are such as to control said computer to encrypted marked text segments using a key sent by a key server:

26. A computer-readable medium having stored thereon computer-readable instructions which, when executed by a computer, control said computer to perform the following process:
automatically detecting the presence of sensitive information in a document and selecting said sensitive information for protection;
displaying the document with the automatically selected sensitive segments visible to a user along with some indication that said sensitive segments have been selected for encryption, redaction or removal;
receiving user approval or disapproval of said automatically selected sensitive segments and receiving any user input selecting additional segments for protection;
once final approval of automatically selected sensitive segments is received and any additional selections are made, protecting the selected sensitive segments;
storing means for restoring the document to irs original unprotected condition.

27. The computer-readable medium of claim 26 wherein said computer-readable instructions include instructions to control said computer to:
display to a user an option to clear all automatically made selections
if said user chooses to clear all automatically made selections, present to said user user interface one or more of the following tools which can be invoked to control said computer to do any one or more of the following things:
change dictionaries which are active and which are being used to make automated selections;
edit words or phrases or activate or deactiate words or phrases of active dictionaries which are being used to make automatic selections or add new words or phrases to use to make automated selections;
change or delete or deactivate automated selections rules which are active and being used to make automated selections of segments of a document for protection or add new rules for automated selection.

28. A computer-readable medium storing computer-readable instructions which, when executed by a computer, control said computer to carry out the following process:
display to a user the following commands as part of the user interface of a host application which supports DCOM or OLE automation:
a) SET MARKER;
b) REMOVE MARKER;
c) ENCRYPT;
d) DECRYPT;
e) AUTOMATED MARKER;
f) CREATE DECRYPT FILE;
g) IMPORT DECRYPT FILE;
h) DICTIONARY;
receive user input invoking said commands and controlling said computer to carry out the following processing in response to each command invoked:
i) if said SET MARKER command is invoked, marking a segment of a document selected by a user for protection;
j) if said REMOVE MARKER command is invoked, removing one or more markers previously set on one or more segments of a document;
k) if said ENCRYPT command is invoked, encrypting all segments of a document previously marked in the document displayed by a host application, and storing a key needed to decrypt each marked segment somewhere outside said document, preferably in a secure store, and storing in said document information sufficient to retrieve the keys needed to decrypt each marked segment;
l) if said DECRYPT command is invoked, using information stored in said document to retrieve the keys needed to decrypt each encrypted segment and decrypting each encrypted segment and displaying the decrypted segment in the same location of the document where it originally existed;
m) if said AUTOMATED MARKER command is invoked, using one or more dictionaries and/or one or more rules designated by a user to select sensitive segments of a document for protection;
n) if said CREATE DECRYPT FILE command is invoked, using segment IDs and keys for the protected segments of a document to create a decrypt file which is stored on a secure server and which allows a user who has suitable privileges who does share the same server as the secure server to import the necessary keys to decrypt each protected segment;
o) if said IMPORT DECRYPT FILE command is invoked, allowing a user who has suitable access privileges to import decryption keys needed to decrypt all the encrypted portions of a protected document; and
p) if said DICTIONARY command is invoked, presenting user interface tools and accepting user input to control the computer to turn on or turn off one or more dictionaries used to make automatic selections of sensitive segments to be protected and allow the user to edit said dictionaries to add or delete words or phrases.

29. The computer-readable medium of claim 28 wherein said computer-readable instructions further comprise instructions to control said computer, when executed, to provide an EDIT RULE command and to receive user input invoking said EDIT RULE command and respond thereto by controlling said computer to display user interface tools and receive user input invoking said user interface tools so as to provide the ability for said user to edit rules used for automatic selection of segments of said document to be protected.

30. The computer-readable medium of claim 28 wherein said computer-readable instructions further comprise instructions to control said computer, when executed, to provide REDACT and UNREDACT commands, and respond to invocation of the REDACT command by controlling said computer to display user interface tools and receive user input invoking said user interface tools so as to provide the ability for said user to block previously selected sensitive segments from viewing by covering the original text with some pattern on the display which obscures the original text and making a copy of the original text which is stored elsewhere, or by removing the original text and storing it elsewhere and replacing it with some redaction indication to indicate where in the document sensitive information has been redacted, and storing pointers in the document which can be followed to find the original text, and to respond to invocation of said UNREDACT command by following pointers in said document to retrieve the original information which has been redacted and put said information back in the document where said information was originally stored so as to restore the document to its original state.

31. The computer-readable medium of claim 28 wherein said computer-readable instructions further comprise instructions to control said computer, when executed, to provide REMOVE and UNREMOVE commands, and respond to invocation of the REMOVE command by controlling said computer to display user interface tools and receive user input invoking said user interface tools so as to provide the ability for said user to block previously selected sensitive segments from viewing by removing the original text from the document to be protected and storing the removed text elsewhere, and storing pointers in the document which can be followed to find the original text, and to respond to invocation of said UNREMOVE command by following pointers in said document to retrieve the original information which has been removed and put said information back in the document where said information was originally stored so as to restore the document to its original state.

32. A computer-readable medium storing computer-readable instructions which, when executed by a computer, control said computer to carry out the following process:
display to a user the following commands as part of the user interface of a host application which supports DCOM or OLE automation:
a) SET MARKER;
b) REMOVE MARKER;
c) REDACT;
d) UNREDACT;
e) AUTOMATED MARKER;
f) DICTIONARY;
receive user input invoking said commands and controlling said computer to carry out the following processing in response to each command invoked:
i) if said SET MARKER command is invoked, marking a segment of a document selected by a user for protection;
j) if said REMOVE MARKER command is invoked, removing one or more markers previously set on one or more segments of a document;
k) if said REDACT command is invoked, redacting all segments of a document previously marked in the document displayed by a host application, and storing the original text of the marked segment somewhere outside said document, preferably in a secure store, and storing in said document information sufficient to retrieve the original text of each marked segment;
l) if said UNREDACT command is invoked, using information stored in said document to retrieve the original text of each redacted segment and storing it in the document in the same location of the document where said redacted text originally existed;
m) if said AUTOMATED MARKER command is invoked, using one or more dictionaries and/or one or more rules designated by a user to select sensitive segments of a document for protection;and
o) if said DICTIONARY command is invoked, presenting user interface tools and accepting user input to control the computer to turn on or turn off one or more dictionaries used to make automatic selections of sensitive segments to be protected and allow the user to edit said dictionaries to add or delete words or phrases.

33. A computer-readable medium storing computer-readable instructions which, when executed by a computer, control said computer to carry out the following process:
presenting user interface tools and functionality to allow a recipient of a protected document to log onto a secure storage server and authenticate herself as authorized to have access to decryption keys needed to decrypt text sections in said document which have been encrypted or original text stored in said server which has been redacted or removed from said protected document, and responding to a login request by attempting to authenticate said recipient; and
if said recipient is authenticated, using pointers stored in said protected document to retrieve either decryption keys needed to decrypt portions of said document which have been encrypted or the original text from said document which has been redacted or removed and supplying said keys or original text to a process which uses said keys or original text to restore the document to its original condition.

34. A computer-readable medium storing computer-readable instructions, which when executed by a first computer cause said first computer to carry out the following web application process to remotely partially encrypt, redact or remove sensitive information in a document stored on a second computer:
executing instructions on said first computer to cause said first computer to establish contact with said second computer and make a function call to an application programmatic interface within a program in execution on said second computer in order to gain access to a document to be protected which is stored on said second computer; and
once access to said document is obtained, performing steps of the following process remotely from said first computer via access to said document stored on said second computer:
a) detecting the presence of sensitive information needing protection in said document stored on said second computer, and selecting said sensitive information;
b) protecting said selected sensitive information by preventing said sensitive information from being viewed;
c) storing a means for bringing the sensitive information back to a state where it can be viewed.

35. A computer-readable medium storing computer-readable instructions which, when executed by a computer, cause said computer to carry out the following process:
using one or more objects in a set of document protection objects linked to objects of a host application supporting DCOM or OLE automation via one or more application programmatic interfaces, displaying a set of document protection user interface tools necessary to control a process to protect sensitive information in a document by partial encryption, partial redaction or partial removal so as to prevent viewing of said sensitive information, said set of user interface tools being part of the user interface of said host application that supports DCOM or OLE automation interfacing;
receiving a command from a user who has invoked a command from said set of document protection user interface tools, said command being to protect a document created or opened by said host applicaton;
in response to receipt of said command, invoking the functionality of the appropriate object or objects in said set of document protection objects to examine the contents of said document and select sensitive information for encryption, redaction or removal in any way;
invoking the appropriate object or objects in said set of document protection functionality objects to encrypt, redact or remove said selected sensitive information so as to block viewing thereof;
invoking the appropriate object or objects in said set of document protection objects to store means to allow said document to be restored to its original condition.

36. A computer-readable medium storing computer-readable instructions which, when executed by a computer, cause said computer to carry out the following process:
A) presenting user interface tools that allow a user to open an email client and download emails;
B) receiving user commands to open an email client and download emails and receiving and storing in an email client inbox the downloaded emails;
C) selecting an email and opening said email in an HTML editor;
D) storing said selected email in a different folder using said HTML editor;
E) presenting user interface commands to allow a user to invoke appropriate functionality to open said email which was stored in step D using a word processor or other application program having integrated document protection functionality and receiving and carrying out user interface commands to open said email which was stored in step D;
F) presenting user interface commands which allow a user to invoke appropriate document protection functionality to select and mark sensitive text to be blocked from view, and receiving user interface commands to select and mark sensitive text and carrying out said commands;
G) presenting user interface commands to allow a user to invoke appropriate commands to protect sensitive text marked in step F, and receiving user interface commands to protect sensitive text marked in step F and reacting thereto by encrypting, redacting or removing the senstive marked text and, in the case of encryption, storing the encrypted text in the email being protected and storing a decryption key in a secure key server and storing in said email being protected a pointer to the decrytion key for every piece of sensitive information encrypted, and, in the case of redaction, redacting each marked section of sensitive text and storing the original text in a secure store and storing a pointer to said original text in said email being protected, and, in the case of removal, removing each marked section of sensitive text and storing the original text in a secure store and storing a pointer to said original text in said email being protected;
H) presenting user interface commands to allow a user to invoke appropriate commands to save the protected email, and receiving a user command to save the protected email and saving the protected email by overwriting the protected version thereof; and
I) deleting the email from said email client inbox.

37. A computer-readable medium having stored thereon computer-readable instructions, which when executed by a computer, cause said computer to execute the following process:
A) displaying user interface tools which can be invoked to cause an email client to invoke an HTML editor for composition of a new email;
B) receiving user input which invokes the compose new email command and responding by launching into execution an HTML editor linked to said email client by a DCOM or OLE automation interface, said HTML editor having integrated therein via a DCOM or OLE automation interface objects which implement document protection functionality;
C) displaying user interface tools which represent commands of said HTML editor and commands to invoke email functions necessary to at least attach attachments to and send any email composed with said HTML editor, and displaying user interface tools representing commands which can be invoked to at least select, mark and protect sensitive text;
D) receiving user input to address an email and compose the text thereof, and receiving user input to invoke a document protection command or commands to select and mark sensitive text in said email to be protected, and carrying out the requested functions;
E) receiving user input invoking document protection commands to protect segments of text marked in step D and carrying out the requested function and storing means to allow a recipient of said email with adequate privileges to restore said email to its original condition;
F) determining if an attachment needing protection is present, and, if not, receiving user input invoking a command to send said protected email and sending said protected email.

38. The computer-readable medium of claim 37 wherein said computer-readable instructions include instructions to carry out step C by displaying user interface tools representing commands which provide a user the ability to select which of one or more dictionaries and/or one or more automatic selection rules are active for purposes of automatic selection of sensitive text.

39. The computer-readable medium of claim 37 wherein said computer-readable instructions include instructions to carry out step C by displaying user interface tools representing commands which provide a user the ability to edit one or more dictionaries and/or one or more automatic selection rules which are active for purposes of automatic selection of sensitive text.

40. The computer-readable medium of claim 37 wherein said computer-readable instructions include instructions to carry out step D by using one or more dictionaries and/or one or more automatic selection rules which are active to do automatic selection of sensitive text.

41. The computer-readable medium of claim 37 wherein said computer-readable instructions include instructions to carry out step D by allowing a user to manually select sensitive text which is then automatically marked for protection.

42. The computer-readable medium of claim 37 wherein said computer-readable instructions include instructions to carry out step E by encrypting sensitive text which has been selected and marked and replacing the marked text with the encrypted version, storing a decyrption key in a secure key server and storing a pointer to said decryption key in said protected email.

43. The computer-readable medium of claim 37 wherein said computer-readable instructions include instructions to carry out step E by redacting sensitive text which has been selected and marked and replacing the original text which has been marked with some indication that the original text has been redacted, storing the original text in a secure store, and storing a pointer to said original text in said protected email.

44. The computer-readable medium of claim 37 wherein said computer-readable instructions include instructions to carry out step E by removing sensitive text which has been selected and marked, storing the original text in a secure store, and storing a pointer to said original text in said protected email.

45. A computer-readable medium having stored thereon computer-readable instructions, which when executed by a computer, cause said computer to execute the following process:
A) opening an attachment to an email, and responding thereto by launching an editor program with document protection functionality integrated therein which can be used to edit said attachement;
B) receiving user input to invoke a document protection command or commands to select and mark sensitive text in said attachment to be protected, and carrying out the requested functions;
C) receiving user input invoking document protection commands to protect segments of text marked in step B and carrying out the requested function and storing means to allow a recipient of said email attachment with adequate privileges to restore said attachment to its original condition.

46. The computer-readable medium of claim 44 wherein said computer-readable instructions are such as to cause step A to be carried out by waiting for a manually entered command to open said attachment and wherein said computer-readable intructions are such as to cause step B to be carried out by displaying automatically selected and marked text for final approval by a user who is provided user interface tools to allow the user to manally select and mark additional text if need be before the marked text is passed for protection to step C.

47. The computer-readable medium of claim 44 wherein said computer readable instructions are such as to cause step A to be carried out by automatically opening said attachment whenever an attachment to an email is present, and wherein said computer-readable intructions are such as to cause step B to be carried out by automatically selecting and marking text for protection using one or more dictionaries and/or one or more automatic selection rules.

48. A computer-readable medium having stored thereon computer-readable instructions, which when executed by a computer, cause said computer to execute the following process:
A) provide user interface tools and functionality to allow a user to launch a web browser and use said web browser to log onto a web mail server and authenticate himself or herself;
B) receive commands and data from said web mail server and using said commands and data to cause said computer to render a web mail user interface window with commands which can be invoked to compose a new email message;
C) receive user input invoking a compose new email command, and sending a message to said web mail server indicating that a new email message is to be composed, and receiving back commands and data from said web mail server which causes said computer to render a compose new email window implemented by an HTML editor which may be a separate editor or said browser and which has document protection functionality integrated therein via a DCOM or OLE automation interface;
D) receiving user input to compose a new email and to invoke said document protection functionality to select sensitive text and mark it and to protect said marked text to block it from view;
E) receiving user input to invoke a send command and responding thereto by sending the email with sensitive text protected from view.

49. A computer-readable medium having stored thereon computer-readable instructions, which when executed by a computer, cause said computer to execute the following process:
A) provide user interface tools and functionality which allow a user to indicate a desire to add an attachment to an email and to cooperate with a web mail server to cause said computer to render windows which allow a user to identify a file to be attached;
B) receiving user input to select an attachment and attaching the selected attachment and rendering a window showing the text of an email, its addressees and the attachment;
C) providing user interface tools and functionality associated therewith which allow a user to open the attachment using an editor program which has integrated therein via a DCOM or OLE automation interface document protection functionality;
D) receiving user input invoking document protection functionality to select sensitive text and mark it for protection and protecting said sensitive text from view; and
E) saving said protected attachment as the attachment which will be sent with the email to which the original unprotected attachment was attached when said email is sent.
